(19) United States
(12) Patent Application Publication
(10) Pub. No.: US 2025/0271549 A1
(43) Pub. Date: Aug. 28, 2025

(54) METHODS, APPARATUS, AND ARTICLES OF MANUFACTURE TO CALIBRATE A RADAR CIRCUIT

(71) Applicant: Texas Instruments Incorporated, Dallas, TX (US)

(72) Inventors: Arnab Das, Bangalore (IN); Yogesh Mahajan, Bangalore (IN); Shankar Ram Narayana Moorthy, Bangalore (IN)

(21) Appl. No.: 18/586,136

(22) Filed: Feb. 23, 2024

(51) Int. Cl. G01S 7/40

(52) U.S. Cl. CPC G01S 7/4013

(57) ABSTRACT

At least one example non-transitory machine-readable storage medium includes machine-readable instructions to cause at least one processor circuit to at least set a control voltage of a power amplifier (PA) of a radar circuit based on a bias code. The at least one non-transitory machine-readable storage medium includes machine-readable instructions to cause the at least one processor circuit to cause a power detector of the radar circuit to measure an output power of the PA. The at least one non-transitory machine-readable storage medium includes machine-readable instructions to cause the at least one processor circuit to, based on a rate of change of the bias code with respect to the output power not corresponding to a change in value of the bias code, set the rate of change based on first values of the bias code and second values of the output power.

### TECHNICAL FIELD

This description relates generally to systems on a chip (SoCs) and, more particularly, to methods, apparatus, and articles of manufacture to calibrate a radar circuit.

### BACKGROUND

Manufacturers of integrated circuits (ICs) have developed techniques to fabricate compact ICs that incorporate components of a computer or other electronic system. Such ICs are referred to as Systems on a Chip, or SoCs. Such SoCs include central processor units (CPUs), memory, input/output ports and secondary storage, all on the same substrate or in the same package. Depending on the application, an SoC may include digital, analog, mixed-signal, radio frequency (RF), or other signal processing functions.

### SUMMARY

For methods, apparatus, and articles of manufacture to calibrate a radar circuit, at least one example non-transitory machine-readable storage medium includes machine-readable instructions to cause at least one processor circuit to at least set a control voltage of a power amplifier (PA) of a radar circuit based on a bias code. The at least one non-transitory machine-readable storage medium includes machine-readable instructions to cause the at least one processor circuit to cause a power detector of the radar circuit to measure an output power of the PA. The at least one non-transitory machine-readable storage medium includes machine-readable instructions to cause the at least one processor circuit to, based on a rate of change of the bias code with respect to the output power not corresponding to a change in value of the bias code, set the rate of change based on first values of the bias code and second values of the output power. Other examples are described.

For methods, apparatus, and articles of manufacture to calibrate a radar circuit, an example radar circuit includes transmitter circuitry including a power amplifier (PA) and a power detector (PD), the PA coupled to the PD. The radar circuit includes control circuitry coupled to the transmitter circuitry, the control circuitry configured to set a control voltage of the PA based on a bias code. The control circuitry is configured to cause the PD to measure an output power of the PA. The control circuitry is configured to, based on a rate of change of the bias code with respect to the output power not corresponding to a change in value of the bias code, set the rate of change based on first values of the bias code and second values of the output power. Other examples are described.

For methods, apparatus, and articles of manufacture to calibrate a radar circuit, an example method includes generating, with a power amplifier (PA) of a radar circuit, a signal based on a bias code. The method includes measuring, with a power detector of the radar circuit, a power of the signal generated by the PA. The method includes, based on a rate of change of the bias code with respect to the power not corresponding to a change in value of the bias code, setting, by using control circuitry, the rate of change based on first values of the bias code and second values of the power. Other examples are described.

### BRIEF DESCRIPTION OF THE DRAWINGS

FIG. 1 is a block diagram of an example radar SoC.

FIG. 2 is a block diagram of an example implementation of the radar control circuitry of FIG. 1.

FIG. 3 is a graphical illustration depicting example calibration of the first power amplifier of the radar SoC of FIG. 1.

FIG. 4 is a graphical illustration depicting example changes in bias code for the first power amplifier of the radar SoC of FIG. 1 over calibration iteration.

FIG. 5 is a graphical illustration depicting example changes in output power of the first power amplifier of the radar SoC of FIG. 1 over calibration iteration.

FIG. 6 is a flowchart representative of at least one of example machine-readable instructions or example operations that may be at least one of executed, instantiated, or performed using an example programmable circuitry implementation of the radar control circuitry of FIG. 2.

FIG. 7 is a flowchart representative of at least one of example machine-readable instructions or example operations that may be at least one of executed, instantiated, or performed using an example programmable circuitry implementation of the radar control circuitry of FIG. 2.

FIG. 8 is a block diagram of an example processing platform including programmable circuitry structured to at least one of execute, instantiate, or perform the example machine-readable instructions or perform the example operations of FIGS. 6 and 7 to implement the radar control circuitry of FIG. 2.

FIG. 9 is a block diagram of an example implementation of the programmable circuitry of FIG. 8.

FIG. 10 is a block diagram of another example implementation of the programmable circuitry of FIG. 8.

FIG. 11 is a block diagram of an example software/firmware/instructions distribution platform (e.g., one or more servers) to distribute at least one of software, instructions, or firmware (e.g., corresponding to the example machine-readable instructions of FIGS. 6 and 7) to client devices associated with at least one of end users (e.g., for license, sale, use, etc.), consumers (e.g., for license, sale, use, etc.), retailers (e.g., for sale, re-sale, license, sub-license, etc.), or original equipment manufacturers (OEMs) (e.g., for inclusion in products to be distributed to, for example, at least one of retailers or to other end users such as direct buy customers).

The same reference numbers or other reference designators are used in the drawings to designate the same or similar (in terms of at least one of functional or structural) features.

### DETAILED DESCRIPTION

The drawings are not necessarily to scale. Generally, the same reference numbers in the drawing(s) and this description refer to the same or like parts. Although the drawings show regions with clean lines and boundaries, some or all of these lines or boundaries may be idealized. In reality, at least one of the boundaries or lines may be at least one of unobservable, blended, or irregular.

There are many advantages to using SoC solutions rather than a distributed architecture. For example, using an SoC solution allows for a smaller area on a printed circuit board (PCB) being consumed as opposed to an equivalent distributed solution. Another advantage of using an SoC solution is that the SoC solution consumes less power than a distributed solution when the SoC solution is integrated on a single substrate. While there are many advantages to using SoC solutions, individual SoCs may require more frequent calibration than a distributed solution. Calibration of an SoC is important to ensure desired functionality of the SoC prior to use in applications for consumers. In one example, such as radio detection and ranging (RADAR or radar) SoC applications, calibration for proper functionality may be very difficult.

Some radar circuits (e.g., transceivers) operate in a millimeter wave (mmWave) frequency range. For example, a radar circuit operating over a bandwidth of 57-64 gigahertz (GHz) is a mmWave radar circuit. In some examples, a radar circuit is a multiple-input multiple-output (MIMO) radar circuit. A transmitter of a radar circuit operating in a mmWave frequency range generates a signal having an output power and, in some examples, includes a configurable backoff (BO) mode to adjust the output power. For example, a transmitter of a radar circuit operating in a mmWave frequency range generates a signal having a high output power (e.g., 11 decibel milliwatts (dBm)) and includes a configurable BO from 0-30 decibels (dB).

To deliver a high output power (e.g., 11 dBm) at mmWave frequencies, a transmitter of a radar circuit includes a multi-stage power amplifier (PA) that is biased to maintain inter-stage matching performance across the bandwidth (e.g., 57-64 GHz) of operation of the radar circuit. Maintaining performance of such a PA (e.g., a multi-stage PA) across process, voltage, and temperature (PVT) variations includes one or more challenges. For example, to maintain performance of a PA across PVT variations, the PA maintains consistent output power (e.g., low variation in output power) across a wide fractional bandwidth (FBW) (e.g., across an FBW of 11.67%). Also, to maintain performance of a PA across PVT variations, the PA maintains inter-stage matching across a wide range of BO (e.g., 0-30 dB) over the full bandwidth (e.g., 7 GHz, 57-64 GHz, etc.) of a radar circuit to deliver accurate BO steps.

Calibration algorithms are implemented to maintain performance of a PA of a transmitter across PVT variations. For example, calibration algorithms include open-loop power calibration (OLPC) algorithms and closed-loop power calibration (CLPC) algorithms. OLPC algorithms predict an initial bias code for CLPC based on one or more equations derived from post-silicon characterization of a radar circuit. CLPC algorithms iterate over bias codes based the Newton Raphson (NR) algorithm to converge on a final bias code. Calibration may be performed each time a radar circuit operates (e.g., each time a radar circuit turns on, when a temperature change occurs in an environment in which a radar circuit is disposed, etc.).

Because calibration time is short, the number of iterations that can be performed for the NR algorithms of CLPC algorithms is less. As such, convergence of the NR algorithm may depend on the accuracy of the gradient at initial iterations in the NR algorithm. However, in a mmWave radar circuit, power measurements performed by a power detector (PD) can be erroneous due to PD analog inaccuracy, PD saturation, or interference issues. For example, a PD can be saturated when the PD samples a power that is above an upper threshold for the PD. Also, for example, a PD can be saturated when the PD samples a power that is below a lower threshold for the PD. As such, CLPC algorithms can converge on erroneous bias codes. Erroneous bias codes degrade transmitter power accuracy. In some examples, erroneous bias codes can cause calibration failure (e.g., in situations where a PD is saturated) under some PVT conditions.

To improve calibration of radar circuits, examples described herein control the gradient (e.g., the slope) of output power with respect to bias code and dampen the change in bias code value between iterations of calibration. For example, described examples determine whether a change in measured output power of a PA corresponds to a change in bias code. If the change in the measured output power does not correspond to the change in bias code, examples described herein override the measured output power with the change in output power expected to correspond to the change in bias code as determined from simulation. As such, described examples avoid complications arising from PD saturation.

Also, described examples determine if the measured output power of a PA satisfies a threshold output power. When the measured output power of the PA does not satisfy the threshold output power, examples described herein utilize a first threshold value for an upper threshold for a change in bias code. When the measured output power of the PA satisfies the threshold output power, examples described herein utilize a second threshold value less than the first threshold value for the upper threshold. As such, described examples dampen bias code steps to improve convergence of calibration to a threshold output power. While examples described herein are described in the context of an example CLPC algorithm, examples described herein are applicable to any calibration technique that utilizes the NR algorithm.

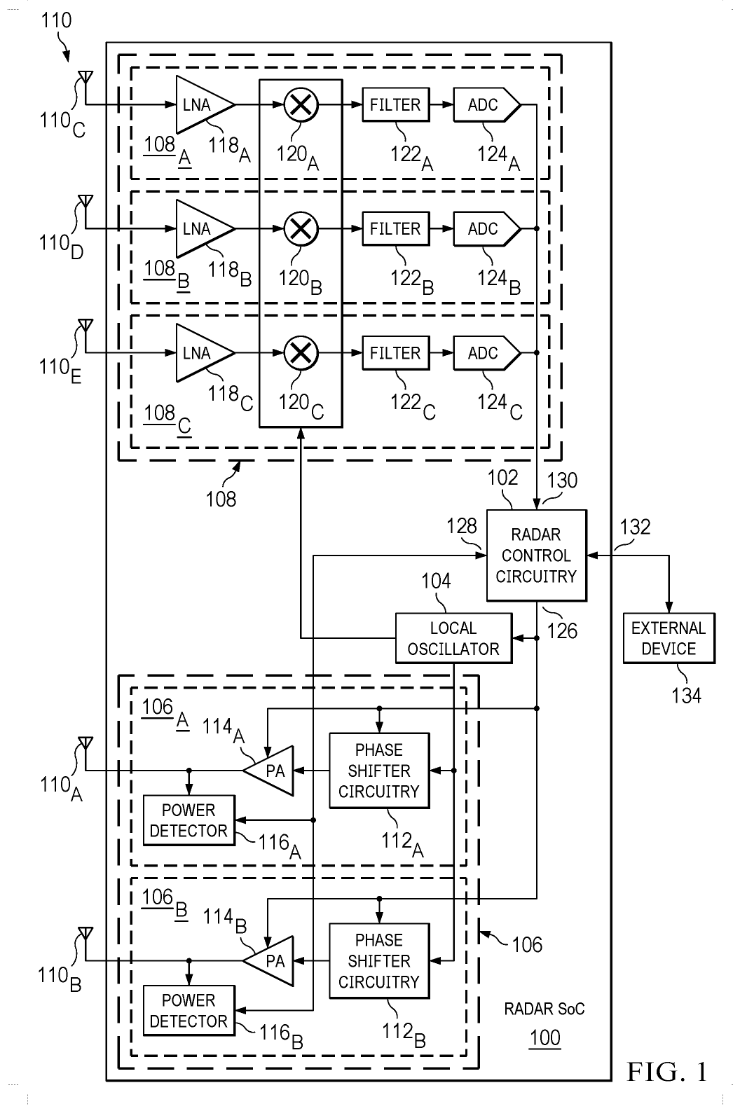

FIG. 1 is a block diagram of an example radar SoC 100. In the example of FIG. 1, the radar SoC 100 is a mmWave radar SoC with a bandwidth of 57-64 GHz. The radar SoC 100 of FIG. 1 includes an example radar control circuitry 102, an example local oscillator 104, example transmitter circuitry 106, example receiver circuitry 108, and example antennas 110. In the example of FIG. 1, the transmitter circuitry 106 includes example first transmitter circuitry 106_{A} and example second transmitter circuitry 106_{B}. The first transmitter circuitry 106_{A} includes example first phase shifter circuitry 112_{A}, an example first power amplifier (PA) 114_{A}, and example first power detector (PD) circuitry 116_{A}. Also, the second transmitter circuitry 106_{B} includes example second phase shifter circuitry 112_{B}, an example second PA 114_{B}, and example second PD circuitry 116_{B}. While FIG. 1 depicts two instances of the transmitter circuitry 106 (e.g., the first transmitter circuitry 106_{A} and the second transmitter circuitry 106_{B}), the radar SoC 100 may include any suitable number of instances of the transmitter circuitry 106.

In the illustrated example of FIG. 1, the receiver circuitry 108 includes example first receiver circuitry 108_{A}, example second receiver circuitry 108_{B}, and example third receiver circuitry 108_{C}. The first receiver circuitry 108_{A} includes an example first low-noise amplifier (LNA) 118_{A}, an example first signal mixer 120_{A}, an example first filter 122_{A}, and an example first analog-to-digital converter (ADC) 124_{A}. Also, the second receiver circuitry 108_{B} includes an example second LNA 118_{B}, an example second signal mixer 120_{B}, an example second filter 122_{B}, and an example second ADC 124_{B}. In the example of FIG. 1, the third receiver circuitry 108_{C} includes an example third LNA 118_{C}, an example third signal mixer 120_{C}, an example third filter 122_{C}, and an example third ADC 124_{C}. As is the case with the transmitter circuitry 106, the number of instances of the receiver circuitry 108 is not limited to any specific number.

In the illustrated example of FIG. 1, the radar control circuitry 102 includes an example output terminal 126 coupled to the local oscillator 104, the first phase shifter circuitry 112_{A}, the second phase shifter circuitry 112_{B}, the first PA 114_{A}, and the second PA 114_{B}. The radar control circuitry 102 also includes an example first input/output (I/O) terminal 128 coupled to the first PD circuitry 116_{A} and the second PD circuitry 116_{B}. Also, the radar control circuitry 102 includes an example input terminal 130 coupled to the first ADC 124_{A}, the second ADC 124_{B}, and the third ADC 124_{C}. In the example of FIG. 1, the radar control circuitry 102 includes an example second I/O terminal 132 coupled to an example remote device 134.

In the illustrated example of FIG. 1, the local oscillator 104 includes an input terminal coupled to the output terminal 126 of the radar control circuitry 102. Also, the local oscillator 104 includes a first output terminal coupled to the first phase shifter circuitry 112_{A} and the second phase shifter circuitry 112_{B}. The local oscillator 104 also includes a second output terminal coupled to the first signal mixer 120_{A}, the second signal mixer 120_{B}, and the third signal mixer 120_{C}. In the example of FIG. 1, the first phase shifter circuitry 112_{A} includes a first input terminal coupled to the output terminal 126 of the radar control circuitry 102. Also, the first phase shifter circuitry 112_{A} includes a second input terminal coupled to the first output terminal of the local oscillator 104. In the example of FIG. 1, the first phase shifter circuitry 112_{A} includes an output terminal coupled to the first PA 114_{A}.

In the illustrated example of FIG. 1, the first PA 114_{A} includes a first input terminal coupled to the output terminal 126 of the radar control circuitry 102. The first PA 114_{A} also includes a second input terminal coupled to the output terminal of the first phase shifter circuitry 112_{A}. Also, the first PA 114_{A} includes an output terminal coupled to an example first antenna 110_{A} and the first PD circuitry 116_{A}. In the example of FIG. 1, the first PD circuitry 116_{A} includes an I/O terminal coupled to the first I/O terminal 128 of the radar control circuitry 102. Also, the first PD circuitry 116_{A} includes an input terminal coupled to the output terminal of the first PA 114_{A}.

In the illustrated example of FIG. 1, the second phase shifter circuitry 112_{B} includes a first input terminal coupled to the output terminal 126 of the radar control circuitry 102. Also, the second phase shifter circuitry 112_{B} includes a second input terminal coupled to the first output terminal of the local oscillator 104. The second phase shifter circuitry 112_{B} also includes an output terminal coupled to the second PA 114_{B}. In the example of FIG. 1, the second PA 114_{B} includes a first input terminal coupled to the output terminal 126 of the radar control circuitry 102. The second PA 114 also includes a second input terminal coupled to the output terminal of the second phase shifter circuitry 112_{B}. Also, the second PA 114 includes an output terminal coupled to an example second antenna 110_{B} and the second PD circuitry 116_{B}. In the example of FIG. 1, the second PD circuitry 116_{B} includes an I/O terminal coupled to the first I/O terminal 128 of the radar control circuitry 102. Also, the second PD circuitry 116_{B} includes an input terminal coupled to the output terminal of the second PA 114_{B}.

In the illustrated example of FIG. 1, the first LNA 118_{A} includes an input terminal coupled to an example third antenna 110_{C}. The first LNA 118_{A} also includes an output terminal coupled to the first signal mixer 120_{A}. In the example of FIG. 1, the first signal mixer 120_{A} includes a first input terminal coupled to the output terminal of the first LNA 118_{A}. Also, the first signal mixer 120_{A} includes a second input terminal coupled to the second output terminal of the local oscillator 104. The first signal mixer 120_{A} also includes an output terminal coupled to the first filter 122_{A}. In the example of FIG. 1, the first filter 122_{A} includes an input terminal coupled to the output terminal of the first signal mixer 120_{A}. Also, the first filter 122_{A} includes an output terminal coupled to the first ADC 124_{A}. In the example of FIG. 1, the first ADC 124_{A} includes an input terminal coupled to the output terminal of the first filter 122_{A}. The first ADC 124_{A} also includes an output terminal coupled to the input terminal 130 of radar control circuitry 102.

In the illustrated example of FIG. 1, the second LNA 118_{B} includes an input terminal coupled to an example fourth antenna 110_{D}. The second LNA 118_{B} also includes an output terminal coupled to the second signal mixer 120_{B}. In the example of FIG. 1, the second signal mixer 120_{B} includes an input terminal coupled to the output terminal of the second LNA 118_{B}. Also, the second signal mixer 120_{B} includes a second input terminal coupled to the second output terminal of the local oscillator 104. The second signal mixer 120_{B} also includes an output terminal coupled to the second filter 122_{B}. In the example of FIG. 1, the second filter 122_{B} includes an input terminal coupled to the output terminal of the second signal mixer 120_{B}. Also, the second filter 122_{B} includes an output terminal coupled to the second ADC 124_{B}. In the example of FIG. 1, the second ADC 124_{B} includes an input terminal coupled to the output terminal of the second filter 122_{B}. The second ADC 124_{B} also includes an output terminal coupled to the input terminal 130 of radar control circuitry 102.

In the illustrated example of FIG. 1, the third LNA 118_{C} includes an input terminal coupled to an example fifth antenna 110_{E}. The third LNA 118_{C} also includes an output terminal coupled to the third signal mixer 120_{C}. In the example of FIG. 1, the third signal mixer 120_{C} includes an input terminal coupled to the output terminal of the third LNA 118_{C}. Also, the third signal mixer 120_{C} includes a second input terminal coupled to the second output terminal of the local oscillator 104. The third signal mixer 120_{C} also includes an output terminal coupled to the third filter 122_{C}. In the example of FIG. 1, the third filter 122_{C} includes an input terminal coupled to the output terminal of the third signal mixer 120_{C}. Also, the third filter 122_{C} includes an output terminal coupled to the third ADC 124_{C}. In the example of FIG. 1, the third ADC 124_{C} includes an input terminal coupled to the output terminal of the third filter 122_{C}. The third ADC 124_{C} also includes an output terminal coupled to the input terminal 130 of radar control circuitry 102.

In the illustrated example of FIG. 1, the radar control circuitry 102 is implemented by programmable circuitry (e.g., one or more general purpose semiconductor-based electrical circuits programmable with instructions, one or more special purpose electrical circuits (e.g., an application specific circuit (ASIC)) structured to perform specific operation(s), etc.). In some examples, the radar control circuitry 102 is implemented by at least one of combinational logic circuitry or sequential logic circuitry. In general, the radar control circuitry 102 is configured to control generation of one or more radar signals via at least one of the first transmitter circuitry 106_{A} or the second transmitter circuitry 106_{B} and at least one of the first antenna 110_{A} or the second antenna 1103, respectively. Also, the radar control circuitry 102 is configured to control processing of one or more reflected signals received by at least one of the third antenna 110_{C}, the fourth antenna 110_{D}, or the fifth antenna 110_{E}. The radar control circuitry 102 also processes one or more digital signals received from at least one of the first ADC 124_{A}, the second ADC 124_{B}, or the third ADC 124_{C} to determine one or more attributes of a target object (e.g., distance, velocity, angle of arrival, etc. of the target object). In the example of FIG. 1, the radar control circuitry 102 also implements a calibration algorithm to calibrate the transmitter circuitry 106. By performing calibration, the radar control circuitry 102 maintains inter-stage matching performance across the bandwidth (e.g., 57-64 GHz) of the first PA 114_{A} and the second PA 114_{B}. For example, the radar control circuitry 102 is coded with firmware to perform calibration of the transmitter circuitry 106.

In the illustrated example of FIG. 1, the radar control circuitry 102 implements a CLPC calibration algorithm to calibrate the transmitter circuitry 106. For example, the radar control circuitry 102 iterates over values of bias codes to set the output power of the first PA 114_{A} and the second PA 114_{B}. In the example of FIG. 1, when the radar control circuitry 102 sets a bias code for a PA, the radar control circuitry 102 sends a control signal to the PA with a voltage corresponding to the value of the bias code. Based on the voltage of the control signal, the PA generates a signal having an output power corresponding to the voltage of the control signal. By implementing the CLPC calibration algorithm, the radar control circuitry 102 converges on a threshold output power for each of the first PA 114_{A} and the second PA 114_{B}.

In the illustrated example of FIG. 1, the calibration algorithm implemented by the radar control circuitry 102 includes output power versus bias code gradient (e.g., slope) control. In the example of FIG. 1, as the radar control circuitry 102 iterates over values of the bias code for first PA 114_{A}, the radar control circuitry 102 determines whether a change (e.g., delta) in measured output power of the first PA 114_{A} corresponds to a change (e.g., delta) in bias code. For example, if the radar control circuitry 102 increases the value of the bias code for the first PA 114_{A}, the radar control circuitry 102 determines if the output power of the first PA 114_{A}, as measured by the first PD circuitry 116_{A}, increased.

In the illustrated example of FIG. 1, if the change in the measured output power does not correspond to the change in bias code (e.g., the bias code value was increased, but the measured output power decreased), the radar control circuitry 102 overrides the measured output power with an expected change in output power that corresponds to the change in bias code. For example, storage of the radar control circuitry 102 includes values for the bias codes of the first PA 114_{A} and the second PA 114_{B} and corresponding expected output powers of the first PA 114_{A} and the second PA 114_{B}, respectively. In the example of FIG. 1, the expected output powers of the first PA 114_{A} and the second PA 114_{B} are at least one of predicted (e.g., via an algorithm) or computed (e.g., via simulation of the first PA 114_{A} and the second PA 114_{B}, by evaluating at least one equation modeling the first PA 114_{A} and the second PA 114_{B}, etc.). In some examples, the expected output powers of the first PA 114_{A} and the second PA 114_{B} are determined in an additional or alternative manner.

In the illustrated example of FIG. 1, the expected output powers of the first PA 114_{A} and the second PA 114_{B} corresponds to expected performance of the first PA 114_{A} and the second PA 114_{B}, respectively, for the corresponding bias code values when measured by the first PD circuitry 116_{A} and the second PD circuitry 116_{B}, respectively, without saturation. For example, an expected output power of the first PA 114_{A} corresponds to an expected performance of the first PA 114_{A} for a corresponding bias code value when measured by the first PD circuitry 116_{A} without saturation. In the example of FIG. 1, by overriding the measured output power of the first PA 114_{A} with an expected output power (e.g., when the measured change in output power does not correspond to a change in bias code), the radar control circuitry 102 forces the change in output power of the first PA 114_{A} versus the change in bias code to be monotonic.

As such, the radar control circuitry 102 controls the direction of the output power versus bias code gradient (e.g., slope) for the first PA 114_{A} to converge the output power of the first PA 114_{A} on a threshold output power. Also, by overriding the measured output power of the first PA 114_{A} with an expected output power (e.g., when the measured change in output power does not correspond to a change in bias code), the radar control circuitry 102 avoids complications arising from PD saturation. For example, as described above, a PD can be saturated when the PD samples a power that is above an upper threshold or below a lower threshold for the PD.

As described above, when a PD is saturated, the power measured by the PD cannot be greater than or less than the upper threshold or lower threshold for the PD. Thus, even if the power sampled by a saturated PD is above the upper threshold for the PD, the measured power detected by the PD will not exceed the upper threshold. Thus, by overriding the measured output power of the first PA 114_{A} with an expected output power (e.g., when the measured change in output power does not correspond to a change in bias code), the radar control circuitry 102 avoids complications arising from PD saturation.

In the illustrated example of FIG. 1, the calibration algorithm implemented by the radar control circuitry 102 includes bias code dampening between iterations of calibration. In the example of FIG. 1, after setting the bias codes for the first PA 114_{A} and the second PA 114_{B}, the radar control circuitry 102 determines whether the output power of the first PA 114_{A} and the second PA 114_{B} satisfy a threshold output power (e.g., a threshold power). For example, the radar control circuitry 102 determines whether the output power of the first PA 114_{A} satisfies a threshold output power. In the example of FIG. 1, the threshold output power is set to a target output power (e.g., 11 dBm).

In the illustrated example of FIG. 1, if the radar control circuitry 102 determines that the output power of the first PA 114_{A} does not satisfy the threshold output power, the radar control circuitry 102 sets an upper threshold for a change in the value of the bias code to a first threshold value (e.g., seven). As such, if the radar control circuitry 102 determines that the output power of the first PA 114_{A} does not satisfy the threshold output power, then the next value for the bias code, as determined by the radar control circuitry 102, will not exceed the current value of the bias code by more than the first threshold value. Also, if the radar control circuitry 102 determines that the output power of the first PA 114_{A} satisfies the threshold output power, the radar control circuitry 102 sets an upper threshold for a change in the value of the bias code to a second threshold value (e.g., three) less than the first threshold value (e.g., seven).

In the illustrated example of FIG. 1, if the radar control circuitry 102 determines that the output power of the first PA 114_{A} satisfies the threshold output power, then the next value for the bias code, as determined by the radar control circuitry 102, will not exceed the current value of the bias code by more than the second threshold value. In this manner, the radar control circuitry 102 implements forced dampening of changes in bias code (e.g., bias code steps) when the output power of the first PA 114_{A} starts to converge on the threshold output power. As such, the output power of the first PA 114_{A} will converge on the threshold output power within the short amount of time available for calibration.

In the illustrated example of FIG. 1, the local oscillator 104 generates a signal to transmit via at least one of the first transmitter circuitry 106_{A} or the second transmitter circuitry 106_{B} based on a signal from the radar control circuitry 102. In the example of FIG. 1, the local oscillator 104 is implemented by at least one of combinational logic circuitry or sequential logic circuitry. For example, the local oscillator 104 includes a digital-to-analog converter (DAC), a voltage-controlled oscillator (VCO), and a bandpass filter. In such an example, the DAC converts signals (e.g., control signals) from the radar control circuitry 102 to analog voltages to control the VCO. Also, in such an example, the output of the VCO is filtered by the bandpass filter to remove high frequency spikes and unwanted harmonics. In such an example, the output of the bandpass filter is output from the local oscillator 104. In the example of FIG. 1, based on a signal from the radar control circuitry 102, the local oscillator 104 generates continuous waveforms.

In the illustrated example of FIG. 1, each of the first phase shifter circuitry 112_{A} and second phase shifter circuitry 112_{B} adjusts the phase of the signal received from the local oscillator 104. In the example of FIG. 1, each of the first phase shifter circuitry 112_{A} and second phase shifter circuitry 112_{B} is implemented by at least one of combinational logic circuitry or sequential logic circuitry. For example, each of the first phase shifter circuitry 112_{A} and second phase shifter circuitry 112_{B} includes a passive analog phase shifter. In additional or alternative examples, each of the first phase shifter circuitry 112_{A} and second phase shifter circuitry 112_{B} includes any phase shifter that is suitable to the application.

In the illustrated example of FIG. 1, each of the first phase shifter circuitry 112_{A} and second phase shifter circuitry 112_{B} includes the functionality to be at least one of enabled or disabled based on a signal (e.g., a control signal) from the radar control circuitry 102. Also, each of the first phase shifter circuitry 112_{A} and second phase shifter circuitry 112_{B} includes the functionality to adjust the phase of the input signal based on a signal (e.g., a control signal) from the radar control circuitry 102 to adjust the frequency of the input signal. For example, each of the first phase shifter circuitry 112_{A} and second phase shifter circuitry 112_{B} varies the phase of the respective output signals with respect to the signal received from the local oscillator 104 at a constant rate to introduce a corresponding frequency shift on the respective output signals.

In the illustrated example of FIG. 1, each of the first PA 114_{A} and the second PA 114_{B} is implemented by at least one of combinational logic circuitry or sequential logic circuitry. For example, each of the first PA 114_{A} and the second PA 114 is implemented by a multi-stage electronic amplifier that converts a low-power radio frequency signal from first phase shifter circuitry 112_{A} and the second phase shifter circuitry 112_{B}, respectively, to a higher power signal to be transmitted via the first antenna 110_{A} and the second antenna 110_{B}, respectively. In the example of FIG. 1, each of the first antenna 110_{A} and the second antenna 110_{B} is implemented by an integrated antenna. For example, each of the first antenna 110_{A} and the second antenna 110_{B} is implemented by at least one of a patch antenna, a microstrip antenna, an antenna-on-package (AoP) antenna, among others.

As described above, each of the first PA 114_{A} and the second PA 114_{B} amplifies a low-power radio frequency signal to a higher power signal to be transmitter by the radar SoC 100. For example, each of the first PA 114_{A} and the second PA 114_{B} generates signals with an output power of up to 11 dBm. Also, each of the first PA 114_{A} and the second PA 114_{B} includes the functionality to be at least one of enabled or disabled by the radar control circuitry 102. Each of the first PA 114_{A} and the second PA 114_{B} also includes a programmable gain that is adjustable by the radar control circuitry 102. For example, the programmable gain of each of the first PA 114_{A} and the second PA 114_{B} is configurable for a backoff from 0-30 dB. In the example of FIG. 1, the programmable gain of each of the first PA 114_{A} and the second PA 114_{B} can be adjusted based on a control voltage received from the radar control circuitry 102. The example control voltage can be adjusted by the radar control circuitry 102 by setting a value of a bias code, as described elsewhere herein.

In the illustrated example of FIG. 1, each of the first PA 114_{A} and the second PA 114_{B} also includes the functionality to introduce binary phase modulation to the signal received from the first phase shifter circuitry 112_{A} and the second phase shifter circuitry 112_{B}, respectively. In this manner, each of the first PA 114_{A} and the second PA 114_{B} is configurable to be at least one of enabled or disabled to introduce binary phase modulation to a signal, depending on the application. For example, each of the first PA 114_{A} and the second PA 114_{B} multiply the signal received from each of the first phase shifter circuitry 112_{A} and the second phase shifter circuitry 112_{B}, respectively, by a signal oscillating between negative one and positive one at a predetermined frequency. In additional or alternative examples, each of the first PA 114_{A} and the second PA 114_{B} is implemented by at least one of a class A, class AB, class B, class C, class F, or a class E amplifier depending on the application.

In the illustrated example of FIG. 1, each of the first PD circuitry 116_{A} and the second PD circuitry 116_{B} is implemented by at least one of combinational logic circuitry or sequential logic circuitry. In the example of FIG. 1, the first PD circuitry 116_{A} measures the output power of signals generated by the first PA 114_{A}. Also, the second PD circuitry 116_{B} measures the output power of signals generated by the second PA 114_{B}. In the example of FIG. 1, each of the first PD circuitry 116_{A} and the second PD circuitry 116_{B} includes the functionality to be at least one of enabled or disabled by the radar control circuitry 102.

In the illustrated example of FIG. 1, each of the first LNA 118_{A}, the second LNA 118_{B}, and the third LNA 118_{C} is an electronic amplifier that amplifies a signal received from the third antenna 110_{C}, the fourth antenna 110_{D}, and the fifth antenna 110_{E}, respectively, without adding additional noise to the signal. In the example of FIG. 1, each of the third antenna 110_{C}, the fourth antenna 110_{D}, and the fifth antenna 110_{E} is implemented by an integrated antenna. For example, each of the third antenna 110_{C}, the fourth antenna 110_{D}, and the fifth antenna 110_{E} is implemented by at least one of a patch antenna, a microstrip antenna, an AoP antenna, among others. In the example of FIG. 1, each of the first LNA 118_{A}, the second LNA 118_{B}, and the third LNA 118_{C} includes the functionality to be at least one of enabled or disabled by the radar control circuitry 102.

In the illustrated example of FIG. 1, each of the first LNA 118_{A}, the second LNA 118_{B}, and the third LNA 118_{C} is implemented by at least one of combinational logic circuitry or sequential logic circuitry. For example, each of the first LNA 118_{A}, the second LNA 118_{B}, and the third LNA 118_{C} includes a peak detector that detects peak frequencies in signals that flow through each of the first LNA 118_{A}, the second LNA 118_{B}, and the third LNA 118_{C}. In additional or alternative examples, each of the first LNA 118_{A}, the second LNA 118_{B}, and the third LNA 118_{C} is implemented by at least one of a class A, class AB, class B, class C, class F, or class E amplifier depending on the application.

In the illustrated example of FIG. 1, each of the first signal mixer 120_{A}, the second signal mixer 120_{B}, and the third signal mixer 120_{C} is implemented by at least one of combinational logic circuitry or sequential logic circuitry. In the example of FIG. 1, each of the first signal mixer 120_{A}, the second signal mixer 120_{B}, and the third signal mixer 120_{C} is an electrical circuit that mixes signals received from the first LNA 118_{A}, the second LNA 118_{B}, and the third LNA 118_{C}, respectively, with the signal generated by the local oscillator 104. For example, each of the first signal mixer 120_{A}, the second signal mixer 120_{B}, and the third signal mixer 120_{C} subtracts the frequency of the signal generated by the local oscillator 104 from the frequency of signals received from the first LNA 118_{A}, the second LNA 118_{B}, and the third LNA 118_{C}, respectively.

In additional or alternative examples, each of the first signal mixer 120_{A}, the second signal mixer 120_{B}, and the third signal mixer 120_{C} adds the frequency of the signal generated by the local oscillator 104 to the frequency of signals received from the first LNA 118_{A}, the second LNA 118_{B}, and the third LNA 118_{C}, respectively. In some examples, each of the first signal mixer 120_{A}, the second signal mixer 120_{B}, and the third signal mixer 120_{C} multiplies the frequency of the signal generated by the local oscillator 104 with the frequency of signals received from the first LNA 118_{A}, the second LNA 118_{B}, and the third LNA 118_{C}, respectively. Regardless of the technique to mix signals, the output of each of the first signal mixer 120_{A}, the second signal mixer 120_{B}, and the third signal mixer 120_{C} is a signal at an intermediate frequency (IF) that is specific to the application.

In the illustrated example of FIG. 1, each of the first filter 122_{A}, the second filter 122_{B}, and the third filter 122_{C} is implemented by a variable gain amplifier bandpass filter. In the example of FIG. 1, each of the first filter 122_{A}, the second filter 122_{B}, and the third filter 122_{C} filters unwanted frequencies from a signal so that the signal is filtered for a desired carrier frequency with a bandwidth wide enough to encompass sidebands (e.g., information transmitted by the signal). For example, the center frequency of each of the first filter 122_{A}, the second filter 122_{B}, and the third filter 122_{C} is tunable.

For example, each of the first filter 122_{A}, the second filter 122_{B}, and the third filter 122_{C} includes a demultiplexer with multiple filters coupled to the demultiplexer. In this manner, each of the first filter 122_{A}, the second filter 122_{B}, and the third filter 122_{C} can be tuned via a control voltage that selects a combination of filters on the demultiplexer to set the center frequency of each of the first filter 122_{A}, the second filter 122_{B}, and the third filter 122_{C}. In additional or alternative examples, each of the first filter 122_{A}, the second filter 122_{B}, and the third filter 122_{C} is implemented by at least one of a lowpass filter, a high pass filter, a network of lowpass and high pass filters, or a combination thereof.

In the illustrated example of FIG. 1, each of the first ADC 124_{A}, the second ADC 124_{B}, and the third ADC 124_{C} is implemented by at least one of combinational logic circuitry or sequential logic circuitry. In the example of FIG. 1, each of the first ADC 124_{A}, the second ADC 124_{B}, and the third ADC 124_{C} is a device that converts an analog signal received from each of first filter 122_{A}, the second filter 122_{B}, and the third filter 122_{C}, respectively. For example, each of the first ADC 124_{A}, the second ADC 124_{B}, and the third ADC 124_{C} converts the analog signal to a digital signal and transmits the digital signal to the radar control circuitry 102.

In the illustrated example of FIG. 1, the remote device 134 is implemented by programmable circuitry (e.g., one or more general purpose semiconductor-based electrical circuits programmable with instructions, one or more special purpose electrical circuits (e.g., an ASIC) structured to perform specific operation(s), etc.). In some examples, the remote device 134 is implemented by at least one of combinational logic circuitry or sequential logic circuitry. In the example of FIG. 1, the remote device 134 is in communication with the radar control circuitry 102. For example, the remote device 134 transmits one or more expected output power values for PAs of the radar SoC 100. In some examples, the remote device 134 transmits machine-readable instructions to the radar control circuitry 102. For example, the machine-readable instructions correspond to the CLPC calibration algorithm described above.

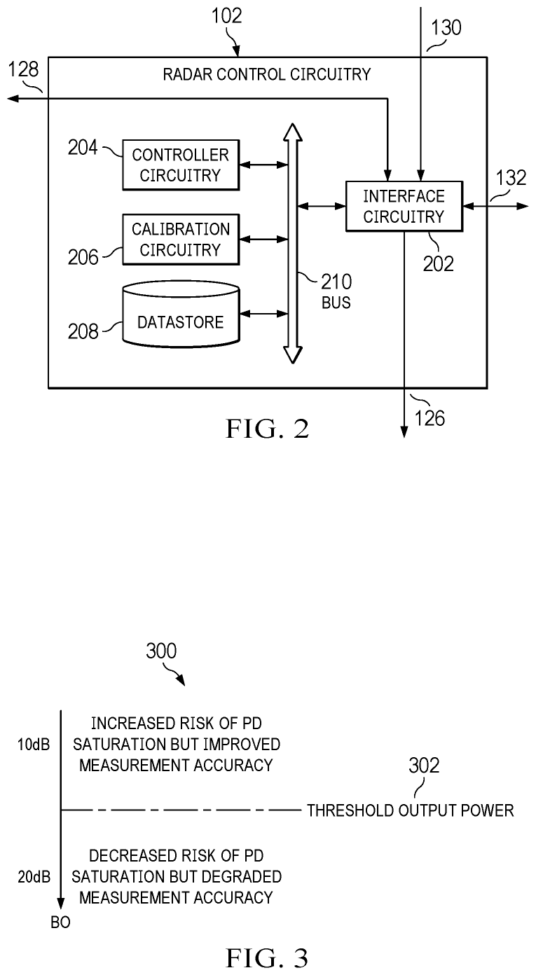

FIG. 2 is a block diagram of an example implementation of the radar control circuitry 102 of FIG. 1. In the example of FIG. 2, the radar control circuitry 102 includes example interface circuitry 202, example controller circuitry 204, example calibration circuitry 206, and an example datastore 208. In the illustrated example of FIG. 2, the interface circuitry 202, the controller circuitry 204, the calibration circuitry 206, and the datastore 208 are coupled via an example bus 210. For example, the bus 210 may be implemented using at least one of any suitable wired or any suitable wireless communication. In additional or alternative examples, the bus 210 includes at least one of software, machine-readable instructions, or communication protocols by which information is communicated among the interface circuitry 202, the controller circuitry 204, the calibration circuitry 206, and the datastore 208.

In the illustrated example of FIG. 2, the radar control circuitry 102 may be instantiated (e.g., creating an instance of, bring into being for any length of time, materialize, implement, etc.) by programmable circuitry such as a Central Processor Unit (CPU) executing first instructions. Also or alternatively, the radar control circuitry 102 of FIG. 2 may be instantiated (e.g., creating an instance of, bring into being for any length of time, materialize, implement, etc.) by at least one of (i) an Application Specific Integrated Circuit (ASIC) or (ii) a Field Programmable Gate Array (FPGA) at least one of structured or configured in response to execution of second instructions to perform operations corresponding to the first instructions. Some or all of the circuitry of FIG. 2 may, thus, be instantiated at the same or different times. Some or all of the circuitry of FIG. 2 may be instantiated, for example, in one or more threads executing at least one of concurrently on hardware or in series on hardware. Moreover, in some examples, some or all of the circuitry of FIG. 2 may be implemented by at least one of microprocessor circuitry executing instructions or FPGA circuitry performing operations to implement at least one of one or more virtual machines or one or more containers.

In the illustrated example of FIG. 2, the interface circuitry 202 is coupled to the local oscillator 104, the first phase shifter circuitry 112_{A}, the second phase shifter circuitry 112_{B}, the first PA 114_{A}, and the second PA 114_{B} via the output terminal 126. Also, the interface circuitry 202 is coupled to the first PD circuitry 116_{A} and the second PD circuitry 116_{B} via the first I/O terminal 128. In the example of FIG. 2, the interface circuitry 202 is coupled to the first ADC 124_{A}, the second ADC 124_{B}, and the third ADC 124_{C} via the input terminal 130. Also, the interface circuitry 202 is coupled to the remote device 134 via the second I/O terminal 132.

In the illustrated example of FIG. 2, the interface circuitry 202 accesses first values for a bias code for a PA and corresponding second values of an output power of the PA. As described above, the first values for the bias code and the corresponding second values of the output power are expected values that are at least one of predicted (e.g., via an algorithm) or computed (e.g., via simulation of the PA, by evaluating at least one equation modeling the PA, etc.). In some examples, the expected values are determined in an additional or alternative manner. In the example of FIG. 2, the interface circuitry 202 transmits a control signal to at least one of the first PA 114_{A} or the second PA 114_{B} to set a backoff in output power. For example, based on a bias code set by the controller circuitry 204, the interface circuitry 202 transmits a control signal having a voltage to a PA. In such an example, the voltage of the control signal corresponds to the bias code. Based on the control signal, the PA generates a signal having an output power corresponding to the bias code.

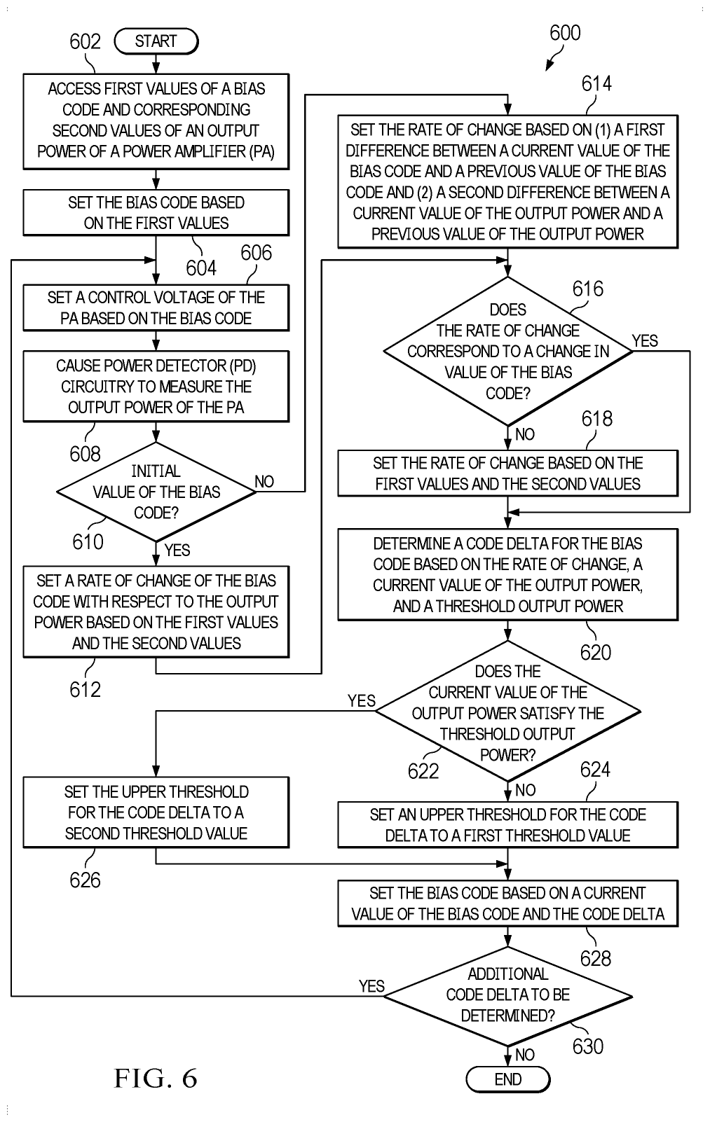

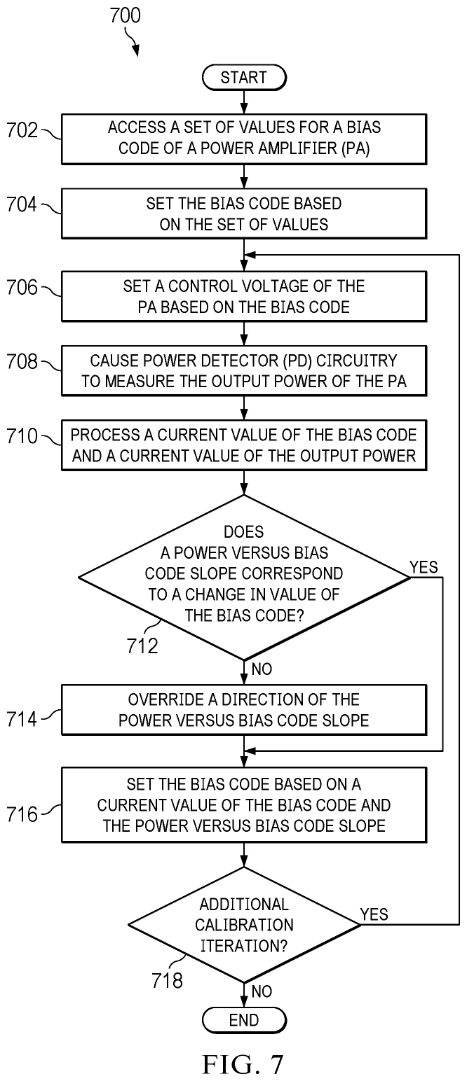

In the illustrated example of FIG. 2, the interface circuitry 202 transmits a signal to at least one of the first PD circuitry 116_{A} or the second PD circuitry 116_{B} to control at least one of the first PD circuitry 116_{A} or the second PD circuitry 116_{B}. For example, based on a request from the controller circuitry 204, the interface circuitry 202 transmits a signal to at least one of the first PD circuitry 116_{A} or the second PD circuitry 116_{B}. Also, the interface circuitry 202 retrieves a signal from at least one of the first PD circuitry 116_{A} or the second PD circuitry 116_{B}. For example, the interface circuitry 202 retrieves an output power measured by at least one of the first PD circuitry 116_{A} or the second PD circuitry 116_{B}. In some examples, the interface circuitry 202 is instantiated by programmable circuitry at least one of executing interfacing instructions or structured to perform operations such as those represented by the flowchart(s) of FIGS. 6 and 7.

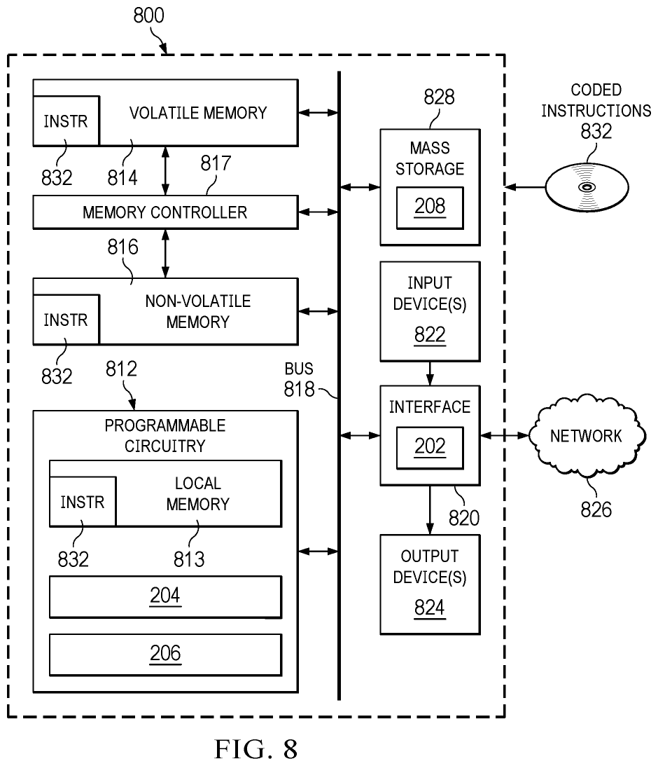

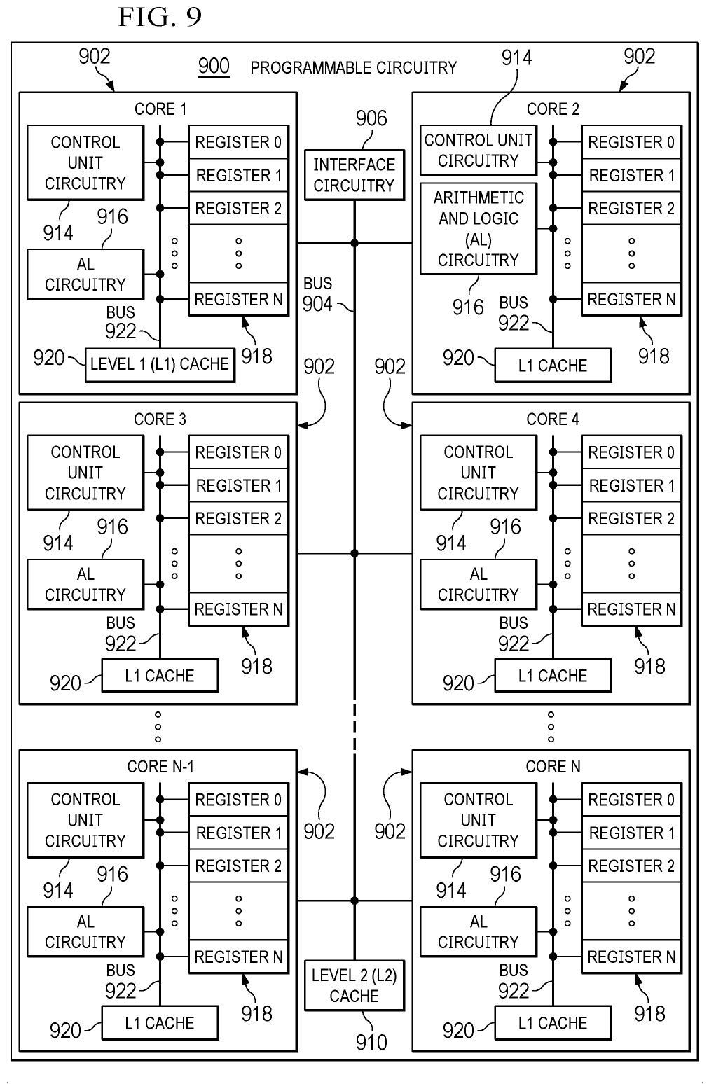

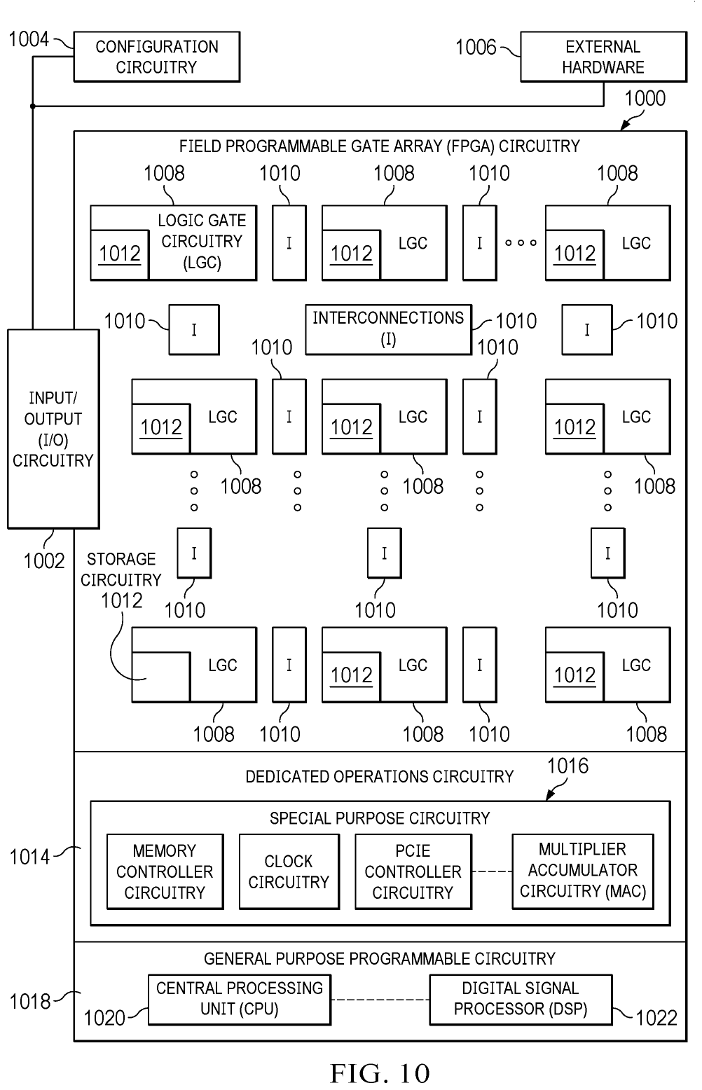

In some examples, the radar control circuitry 102 includes means for interfacing with circuitry. For example, the means for interfacing may be implemented by the interface circuitry 202. In some examples, the interface circuitry 202 may be instantiated by programmable circuitry such as the example programmable circuitry 812 of FIG. 8. For instance, the interface circuitry 202 may be instantiated by the example microprocessor 900 of FIG. 9 executing machine-executable instructions such as those implemented by one or more of at least block 602 of FIG. 6 or at least block 702 of FIG. 7. In some examples, the interface circuitry 202 may be instantiated by hardware logic circuitry, which may be implemented by an ASIC, XPU, or the FPGA circuitry 1000 of FIG. 10 structured to perform operations corresponding to the machine-readable instructions. Also or alternatively, the interface circuitry 202 may be instantiated by any other combination of at least one of hardware, software, or firmware. For example, the interface circuitry 202 may be implemented by at least one or more hardware circuits (e.g., processor circuitry, discrete analog circuitry, discrete digital circuitry, integrated analog circuitry, integrated digital circuitry, an FPGA, an ASIC, an XPU, a comparator, an operational-amplifier (op-amp), a logic circuit, etc.) structured to at least one of execute some or all of the machine-readable instructions or perform some or all of the operations corresponding to the machine-readable instructions without executing software or firmware, but other structures are likewise appropriate.

In the illustrated example of FIG. 2, the controller circuitry 204 controls circuitry of the radar SoC 100. In the example of FIG. 2, the controller circuitry 204 sets a bias code for at least one of the first PA 114_{A} or the second PA 114_{B}. For example, the controller circuitry 204 sets a bias code based on a set of bias code values and corresponding expected output powers. Also or alternatively, the controller circuitry 204 sets a bias code based on a current value of the bias code and a code delta computed by the calibration circuitry 206.

In the illustrated example of FIG. 2, the controller circuitry 204 sets a control voltage for at least one of the first PA 114_{A} or the second PA 114_{B} based on a value of a bias code for the at least one of the first PA 114_{A} or the second PA 114_{B}. Also, the controller circuitry 204 transmits a request to the interface circuitry 202 for at least one of the first PD circuitry 116_{A} or the second PD circuitry 116_{B} to measure the output power of at least one of the first PA 114_{A} or the second PA 114_{B}, respectively. In some examples, the controller circuitry 204 is instantiated by programmable circuitry at least one of executing controller instructions or structured to perform operations such as those represented by the flowchart(s) of FIGS. 6 and 7.

In some examples, the radar control circuitry 102 includes means for controlling circuitry. For example, the means for controlling may be implemented by the controller circuitry 204. In some examples, the controller circuitry 204 may be instantiated by programmable circuitry such as the example programmable circuitry 812 of FIG. 8. For instance, the controller circuitry 204 may be instantiated by the example microprocessor 900 of FIG. 9 executing machine-executable instructions such as those implemented by one or more of at least blocks 604, 606, 608, and 628 of FIG. 6 or at least blocks 704, 706, 708, and 716 of FIG. 7. In some examples, the controller circuitry 204 may be instantiated by hardware logic circuitry, which may be implemented by an ASIC, XPU, or the FPGA circuitry 1000 of FIG. 10 structured to perform operations corresponding to the machine-readable instructions. Also or alternatively, the controller circuitry 204 may be instantiated by any other combination of at least one of hardware, software, or firmware. For example, the controller circuitry 204 may be implemented by at least one or more hardware circuits (e.g., processor circuitry, discrete analog circuitry, discrete digital circuitry, integrated analog circuitry, integrated digital circuitry, an FPGA, an ASIC, an XPU, a comparator, an operational-amplifier (op-amp), a logic circuit, etc.) structured to at least one of execute some or all of the machine-readable instructions or perform some or all of the operations corresponding to the machine-readable instructions without executing software or firmware, but other structures are likewise appropriate.

In the illustrated example of FIG. 2, the calibration circuitry 206 sets a rate of change of a bias code for a PA with respect to an output power of the PA. For example, the calibration circuitry 206 determines if the value of the bias code is an initial value. Based on (e.g., in response to) the calibration circuitry 206 determining that the value of the bias code is the initial value of the bias code, the calibration circuitry 206 sets the rate of change of the bias code with respect the output power based on the set of bias code values and corresponding expected output powers. Based on (e.g., in response to) the calibration circuitry 206 determining that the value of the bias code is not the initial value of the bias code, the calibration circuitry 206 sets the rate of change of the bias code with respect the output power based on (1) a first difference between a current value of the bias code and a previous value of the bias code and (2) a second difference between a current value of the output power and a previous value of the output power.

For example, based on (e.g., in response to) the calibration circuitry 206 determining that the value of the bias code is not the initial value of the bias code, the calibration circuitry 206 sets the rate of change (e.g., slope) of the bias code with respect the output power based on Equation 1 below.

$$Rate of Change = \frac{Bias {Code}_{i} - Bias {Code}_{i - 1}}{Output {Power}_{i} - Output {Power}_{i - 1}} \qquad Equation 1$$

In the illustrated example of FIG. 2, the calibration circuitry 206 determines whether the rate of change (e.g., slope) corresponds to a change in value of the bias code. For example, if the controller circuitry 204 increased the value of the bias code, the calibration circuitry 206 determines whether the output power of a PA measured by corresponding PD circuitry increased. Also, for example, if the controller circuitry 204 decreased the value of the bias code, the calibration circuitry 206 determines whether the output power of a PA measured by corresponding PD circuitry decreased. Based on (e.g., in response to) the calibration circuitry 206 determining that the rate of change does not correspond to the change in value of the bias code, the calibration circuitry 206 overrides the rate of change. For example, the calibration circuitry 206 sets the rate of change based on the set of bias code values and corresponding expected output powers.

In the illustrated example of FIG. 2, based on (e.g., in response to) the calibration circuitry 206 determining that the rate of change corresponds to the change in value of the bias code, the calibration circuitry 206 does not override the rate of change. In the example of FIG. 2, the calibration circuitry 206 determines a code delta for the bias code based on the rate of change, a current value of the output power, and a threshold output power. For example, the calibration circuitry 206 determines the code delta for the bias code based on Equation 2 below.

$$Code Delta = Rate of Change * ( Output {Power}_{Thresh} - Output {Power}_{i} ) \qquad Equation 2$$

In the illustrated example of FIG. 2, the calibration circuitry 206 determines if the current value of the output power satisfies the threshold output power. For example, the threshold output power corresponds to a target output power (e.g., 11 dBm) for at least one of the first PA 114_{A} or the second PA 114_{B}. Based on (e.g., in response to) the calibration circuitry 206 determining that the current value of the output power does not satisfy the threshold output power, the calibration circuitry 206 sets an upper threshold for the code delta to a first threshold value (e.g., seven). As such, if the calibration circuitry 206 determines that the output power of a PA does not satisfy the threshold output power, then the next value for the bias code, as determined by the controller circuitry 204, will not exceed the current value of the bias code by more than the first threshold value. Based on (e.g., in response to) the calibration circuitry 206 determining that the output power of a PA satisfies the threshold output power, the calibration circuitry 206 sets an upper threshold for the code delta to a second threshold value (e.g., three) less than the first threshold value (e.g., seven). As such, if the calibration circuitry 206 determines that the output power of a PA satisfies the threshold output power, then the next value for the bias code, as determined by the controller circuitry 204, will not exceed the current value of the bias code by more than the second threshold value.

In the illustrated example of FIG. 2, to set the upper threshold for the code delta to the first threshold value, the calibration circuitry 206 configures the format of a variable to store the code delta to 4.12 format. In the example of FIG. 2, the calibration circuitry 206 causes storage (e.g., is configured to cause storage) of the variable to store the code delta in 4.12 format. For example, the calibration circuitry 206 sends at least one signal to the datastore 208 to change the format of the variable to store the code delta to 4.12 format. In the example of FIG. 2, 4.12 format is a format for storing a 16-bit value where the first 4-bits are reserved for specifying the integer portion of the value and the next 12-bits are reserved for specifying the fractional portion of the value. In the example of FIG. 2, within the first 4-bits, the first bit specifies the sign of the integer portion, and the next 3-bits specify the integer value. As such, values stored in 4.12 format are less than 8 (e.g. [0, 8)).

In the illustrated example of FIG. 2, to set the upper threshold for the code delta to the second threshold value, the calibration circuitry 206 configures the format of the variable to store the code delta to 3.13 format. In the example of FIG. 2, the calibration circuitry 206 causes storage (e.g., is configured to cause storage) of the variable to store the code delta in 3.13 format. For example, the calibration circuitry 206 sends at least one signal to the datastore 208 to change the format of the variable to store the code delta to 3.13 format. In the example of FIG. 2, 3.13 format is a format for storing a 16-bit value where the first 3-bits are reserved for specifying the integer portion of the value and the next 13-bits are reserved for specifying the fractional portion of the value. In the example of FIG. 2, within the first 3-bits, the first bit specifies the sign of the integer portion, and the next 2-bits specify the integer value. As such, values stored in 3.13 format are less than 4 (e.g. [0, 4)).

In the illustrated example of FIG. 2, by storing the first threshold value in 4.12 format and by storing the second threshold value in 3.13 format, the calibration circuitry 206 improves performance of the radar control circuitry 102. For example, by storing the first threshold value in 4.12 format and by storing the second threshold value in 3.13 format, firmware to implement the radar control circuitry 102 can omit at least one of if statements or for loops to dampen the change in bias code value between iterations of calibration. By omitting at least one of if statements or for loops to dampen the change in bias code value, the calibration circuitry 206 reserves time to perform additional iterations of calibration. In some examples, the calibration circuitry 206 is instantiated by programmable circuitry at least one of executing calibration instructions or structured to perform operations such as those represented by the flowchart(s) of FIGS. 6 and 7.

In some examples, the radar control circuitry 102 includes means for calibrating circuitry. For example, the means for calibrating may be implemented by the calibration circuitry 206. In some examples, the calibration circuitry 206 may be instantiated by programmable circuitry such as the example programmable circuitry 812 of FIG. 8. For instance, the calibration circuitry 206 may be instantiated by the example microprocessor 900 of FIG. 9 executing machine-executable instructions such as those implemented by one or more of at least blocks 610, 612, 614, 616, 618, 620, 622, 624, 626, and 630 of FIG. 6 or at least blocks 710, 712, 714, and 718 of FIG. 7. In some examples, the calibration circuitry 206 may be instantiated by hardware logic circuitry, which may be implemented by an ASIC, XPU, or the FPGA circuitry 1000 of FIG. 10 structured to perform operations corresponding to the machine-readable instructions. Also or alternatively, the calibration circuitry 206 may be instantiated by any other combination of at least one of hardware, software, or firmware. For example, the calibration circuitry 206 may be implemented by at least one or more hardware circuits (e.g., processor circuitry, discrete analog circuitry, discrete digital circuitry, integrated analog circuitry, integrated digital circuitry, an FPGA, an ASIC, an XPU, a comparator, an operational-amplifier (op-amp), a logic circuit, etc.) structured to at least one of execute some or all of the machine-readable instructions or perform some or all of the operations corresponding to the machine-readable instructions without executing software or firmware, but other structures are likewise appropriate.

In the illustrated example of FIG. 2, the datastore 208 records data. For example, the datastore 208 records a set of bias code values and corresponding expected output power values. Also or alternatively, the datastore 208 records a current value of a bias code for at least one of the first PA 114_{A} or the second PA 114_{B} and at least one previous value of the bias code. In the example of FIG. 2, the datastore 208 records a current value of an output power of at least one of the first PA 114_{A} or the second PA 114_{B} and at least one previous value of the output power. The datastore 208 also records a code delta for the bias code for at least one of the first PA 114_{A} or the second PA 114_{B}. As described above, the datastore 208 stores the code delta in at least one of 4.12 format or 3.13 format. In the example of FIG. 2, the datastore 208 records a rate of change of a bias code for at least one of the first PA 114_{A} or the second PA 114_{B} with respect to an output power of the at least one of the first PA 114_{A} or the second PA 114_{B}. The datastore 208 also records a threshold output power for at least one of the first PA 114_{A} or the second PA 114_{B}.

In the illustrated example of FIG. 2, the datastore 208 may be implemented by at least one of a volatile memory (e.g., a Synchronous Dynamic Random Access Memory (SDRAM), Dynamic Random Access Memory (DRAM), RAMBUS Dynamic Random Access Memory (RDRAM), etc.) or a non-volatile memory (e.g., flash memory). The datastore 208 may also or alternatively be implemented by one or more double data rate (DDR) memories, such as DDR, DDR2, DDR3, DDR4, DDR5, mobile DDR (mDDR), DDR SDRAM, etc. The datastore 208 may also or alternatively be implemented by one or more mass storage devices such as hard disk drive(s) (HDD(s)), compact disk (CD) drive(s), digital versatile disk (DVD) drive(s), solid-state disk (SSD) drive(s), Secure Digital (SD) card(s), CompactFlash (CF) card(s), etc. While in the illustrated example the datastore 208 is illustrated as a single datastore, the datastore 208 may be implemented by at least one of any number or any type(s) of datastores. Furthermore, the data stored in the datastore 208 may be in any data format such as, for example, binary data, comma delimited data, tab delimited data, structured query language (SQL) structures, etc.

While an example manner of implementing the radar control circuitry 102 of FIG. 1 is illustrated in FIG. 2, one or more of the elements, processes, or devices illustrated in FIG. 2 may be at least one of combined, divided, re-arranged, omitted, eliminated, or implemented in any other way. Further, at least one of the example interface circuitry 202, the example controller circuitry 204, the example calibration circuitry 206, or the example datastore 208, or, more generally, the example radar control circuitry 102 of FIG. 2, may be implemented by hardware alone or by hardware in combination with at least one of software or firmware. Thus, for example, any of the example interface circuitry 202, the example controller circuitry 204, the example calibration circuitry 206, or the example datastore 208, or, more generally, the example radar control circuitry 102, could be implemented by at least one of programmable circuitry in combination with machine-readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), or field programmable logic device(s) (FPLD(s)) such as FPGAs. Further still, the example radar control circuitry 102 of FIG. 2 may include one or more elements, processes, or devices in addition to, or instead of, those illustrated in FIG. 2, or may include more than one of any or all of the illustrated elements, processes, and devices.

FIG. 3 is a graphical illustration 300 depicting example calibration of the first PA 114_{A} of the radar SoC 100 of FIG. 1. FIG. 3 illustrates the tradeoff between increasing and decreasing the backoff of the first PA 114_{A}. For example, by increasing the backoff of the first PA 114_{A}, which decreases the output power of the first PA 114_{A}, the radar control circuitry 102 decreases the risk of saturating the first PD circuitry 116_{A}. However, increasing the backoff of the first PA 114_{A} also degrades the measurement accuracy of the first PD circuitry 116_{A}. Also, by decreasing the backoff of the first PA 114_{A}, which increases the output power of the first PA 114_{A}, the radar control circuitry 102 increases the risk of saturating the first PD circuitry 116_{A}. However, decreasing the backoff of the first PA 114_{A} also improves the measurement accuracy of the first PD circuitry 116_{A}. By implementing example calibration described herein, the radar control circuitry 102 sets the output power of the first PA 114_{A} to an example threshold output power 302 that avoids saturation of the first PD circuitry 116_{A} and improves measurement accuracy of the first PD circuitry 116_{A}.

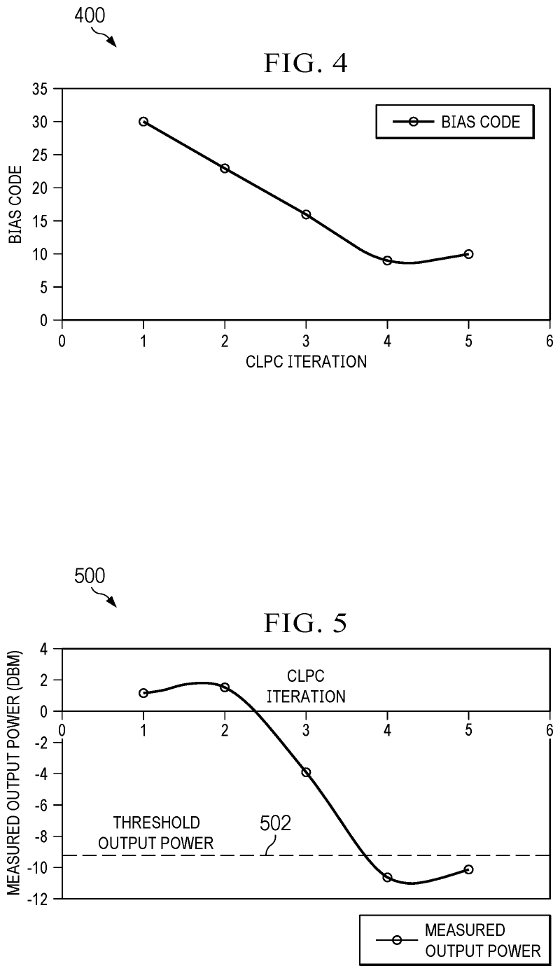

FIG. 4 is a graphical illustration 400 depicting example changes in bias code for the first PA 114_{A} of the radar SoC 100 of FIG. 1 over calibration iteration. Also, FIG. 5 is a graphical illustration 500 depicting example changes in output power of the first PA 114_{A} of the radar SoC 100 of FIG. 1 over calibration iteration. FIGS. 4 and 5 illustrate that the radar control circuitry 102 converges on an example threshold output power 502 and does not fail to calibrate the first PA 114_{A}. Also, the FIGS. 4 and 5 illustrate that the radar control circuitry 102 converges on the threshold output power 502 in five iterations of calibration. As such, example calibration described herein converges on a threshold output power more quickly than other approaches.

FIG. 6 is a flowchart representative of at least one of example machine-readable instructions or example operations 600 that may be at least one of executed, instantiated, or performed using an example programmable circuitry implementation of the radar control circuitry 102 of FIG. 2. The at least one of the example machine-readable instructions or the example operations 600 of FIG. 6 begin at block 602, at which the interface circuitry 202 accesses first values of a bias code and corresponding second values of an output power of a PA. For example, the first values of a bias code and the corresponding second values are expected values being at least one of simulated or predicted.

In the illustrated example of FIG. 6, at block 604, the controller circuitry 204 sets a bias code for the PA based on the first values. At block 606, the controller circuitry 204 sets a control voltage of the PA based on the bias code. In the example of FIG. 6, at block 608, the controller circuitry 204 causes PD circuitry to measure the output power of the PA. At block 610, the calibration circuitry 206 determines whether a current value of the bias code is an initial value of the bias code. Based on (e.g., in response to) the calibration circuitry 206 determining that the current value of the bias code is the initial value of the bias code (block 610: YES), the at least one of the example machine-readable instructions or the example operations 600 proceed to block 612. At block 612, the calibration circuitry 206 sets a rate of change of the bias code with respect the output power based on the first values and the second values.

In the illustrated example of FIG. 6, based on (e.g., in response to) the calibration circuitry 206 determining that the current value of the bias code is not the initial value of the bias code (block 610: NO), the at least one of the example machine-readable instructions or the example operations 600 proceed to block 614. At block 614, the calibration circuitry 206 sets the rate of change of the bias code with respect the output power based on (1) a first difference between a current value of the bias code and a previous value of the bias code and (2) a second difference between a current value of the output power and a previous value of the output power. At block 616, the calibration circuitry 206 determines whether the rate of change (e.g., slope) corresponds to a change in value of the bias code.

In the illustrated example of FIG. 6, based on (e.g., in response to) the calibration circuitry 206 determining that the rate of change does not correspond to the change in value of the bias code (block 616: NO), the at least one of the example machine-readable instructions or the example operations 600 proceed to block 618. At block 618, the calibration circuitry 206 sets the rate of change based on the first values and the second values. Based on (e.g., in response to) the calibration circuitry 206 determining that the rate of change corresponds to the change in value of the bias code (block 616: YES), the at least one of the example machine-readable instructions or the example operations 600 proceed to block 620. At block 620, the calibration circuitry 206 determines a code delta for the bias code based on the rate of change, a current value of the output power, and a threshold output power. For example, the calibration circuitry 206 determines the code delta for the bias code based on Equation 2 described above.

In the illustrated example of FIG. 6, at block 622, the calibration circuitry 206 determines whether the current value of the output power satisfies the threshold output power. Based on (e.g., in response to) the calibration circuitry 206 determining that the current value of the output power does not satisfy the threshold output power (block 622: NO), the at least one of the example machine-readable instructions or the example operations 600 proceed to block 624. At block 624, the calibration circuitry 206 sets an upper threshold for the code delta to a first threshold value (e.g., seven). As described above, to set the upper threshold for the code delta to the first threshold value, the calibration circuitry 206 configures the format of a variable to store the code delta to 4.12 format.

In the illustrated example of FIG. 6, based on (e.g., in response to) the calibration circuitry 206 determining that the output power of a PA satisfies the threshold output power (block 622: YES), the at least one of the example machine-readable instructions or the example operations 600 proceed to block 626. At block 626, the calibration circuitry 206 sets an upper threshold for the code delta to a second threshold value (e.g., three) less than the first threshold value (e.g., seven). As described above, to set the upper threshold for the code delta to the second threshold value, the calibration circuitry 206 configures the format of the variable to store the code delta to 3.13 format. At block 628, the controller circuitry 204 sets the bias code based on a current value of the bias code and the code delta.

In the illustrated example of FIG. 6, at block 630, the calibration circuitry 206 determines if there is an additional code delta to be determined. Based on (e.g., in response to) the calibration circuitry 206 determining that there is an additional code delta to be determined (block 630: YES), the at least one of the example machine-readable instructions or the example operations 600 return to block 606. Based on (e.g., in response to) the calibration circuitry 206 determining that there is not an additional code delta to be determined (block 630: NO), the at least one of the example machine-readable instructions or the example operations 600 terminate.

FIG. 7 is a flowchart representative of at least one of example machine-readable instructions or example operations that may be at least one of executed, instantiated, or performed using an example programmable circuitry implementation of the radar control circuitry 102 of FIG. 2. The at least one of the example machine-readable instructions or the example operations 700 of FIG. 7 begin at block 702, at which the at which the interface circuitry 202 accesses a set of values for a bias code of a PA. For example, the set of values for the bias code are expected values being at least one of simulated or predicted. In the example of FIG. 7, at block 704, the controller circuitry 204 sets the bias code for the PA based on the set of values. At block 706, the controller circuitry 204 sets a control voltage of the PA based on the bias code. For example, the controller circuitry 204 applies the bias code to the PA for a certain backoff and temperature.

In the illustrated example of FIG. 7, at block, at block 708, the controller circuitry 204 causes PD circuitry to measure the output power of the PA. At block 710, the calibration circuitry 206 processes a current value of the bias code and a current value of the output power. For example, at block 710, the calibration circuitry 206 determines a power versus bias code slope for the calibration. At block 712, the calibration circuitry 206 determines if the power versus bias code slope corresponds to a change in value of the bias code. Based on (e.g., in response to) the calibration circuitry 206 determining that the power versus bias code slope does not correspond to a change in value of the bias code (block 712: NO), the at least one of the example machine-readable instructions or the example operations 700 proceed to block 714.

In the illustrated example of FIG. 7, at block 714, the calibration circuitry 206 overrides a direction of the power versus bias code slope. For example, the calibration circuitry 206 overrides the direction of the power versus bias code slop based on expected values for the output power of the PA. Returning to block 712, based on (e.g., in response to) the calibration circuitry 206 determining that the power versus bias code slope corresponds to a change in value of the bias code (block 712: YES), the at least one of the example machine-readable instructions or the example operations 700 proceed to block 716. At block 716, the controller circuitry 204 sets the bias code based on a current value of the bias code and the power versus bias code slope.

In the illustrated example of FIG. 7, at block 718, the calibration circuitry 206 determines if there is an additional calibration iteration. Based on (e.g., in response to) the calibration circuitry 206 determining that there an additional calibration iteration (block 718: YES), the at least one of the example machine-readable instructions or the example operations 700 return to block 706. Based on (e.g., in response to) the calibration circuitry 206 determining that there is not an additional calibration iteration (block 718: NO), the at least one of the example machine-readable instructions or the example operations 700 terminate.

As described above, after that the PD circuitry present at the output terminal of the PA measures the output power and returns the measured output power to the radar control circuitry 102, the calibration circuitry 206 implements an algorithm that generates a subsequent bias code and applies the bias code to the PA. The calibration of FIGS. 6 and 7 converges on a bias code that causes PAs to generate signals having an output power that satisfies a threshold output power. Described convergence direction control and bias code step dampening avoids issues related to PD saturation as well as avoids oscillatory behavior of bias code values between subsequent iterations of calibration (e.g., that may be caused by PD analog inaccuracies).

Pseudocode 1 below illustrates example pseudocode to implement the radar control circuitry 102 of FIG. 2 as shown in the flowcharts of FIGS. 6 and 7.

Pseudocode 1

| | |
|---|---|
| 1. | Global Default_Code_Slope; |
| 2. | Global Array Tx_Code_History; |
| 3. | Global Array Measured_Power_History; |
| 4. | |
| 5. | Define Predict_Next_Tx_Stage_Code(Current_Code, Target_Power, Current_Power, Iteration) |
| 6. | var Power_Diff = Target_Power − Current_Power |
| 7. | var Slope; |
| 8. | If (Iteration = 0) Then |
| 9. | Slope = Default_Code_Slope; |
| 10. | Else |
| 11. | Slope = (Current_Code − Tx_Code_History[Iteration − 1])/(Current_Power − |
| | Measured_Power_History[Iteration − 1]) |
| 12. | If Slope <= 0 Then |
| 13. | Slope = Default_Code_Slope |
| 14. | EndIf |
| 15. | |
| 16. | var Code_Diff = Slope*Power_Diff; |
| 17. | If Code_Diff = 0 Then |
| 18. | Code_Diff = 1 |
| 19. | EndIf |
| 20. | |
| 21. | Code_Diff = Limit_Code_Diff_For_Iteration(Code_Diff, Iteration) |
| 22. | |
| 23. | var New_Code = Current_Code + Code_Diff; |
| 24. | |
| 25. | Measured_Power_History[Iteration] = Current_Code |
| 26. | Tx_Code_History[Iteration] = New_Code |

In the illustrated example of Pseudocode 1, at line 1, the calibration circuitry 206 defines a default code slope for a PA. For example, the calibration circuitry 206 defines the default code slope based on a set of bias code values and corresponding expected output power values for the PA. In the example of Pseudocode 1, at lines 8-11, the calibration circuitry 206 implements an if/else statement to determine if the iteration of the calibration is an initial iteration (e.g., 0). If the calibration circuitry 206 determines that the iteration of the calibration is the initial iteration, the calibration circuitry 206 sets a slope for the bias code versus output power based on the default code slope. If the calibration circuitry 206 determines that the iteration of the calibration is not the initial iteration, the calibration circuitry 206 sets the slope for the bias code versus output power based on (1) a first difference between a current value of the bias code and a previous value of the bias code and (2) a second difference between a current value of the output power and a previous value of the output power.

In the illustrated example of Pseudocode 1, at lines 12-14, the calibration circuitry 206 implements an if/else statement to determine if the slope corresponds to the change in bias code. For example, the calibration circuitry 206 determines if the slope is less than or equal to zero. If the calibration circuitry 206 determines that the slope is less than or equal to zero, the calibration circuitry 206 overrides the determined with the default code slope. If the calibration circuitry 206 determines that the slope is not less than or equal to zero, the calibration circuitry 206 does not override the determined slope.

In the illustrated example of Pseudocode 1, at line 16, the calibration circuitry 206 determines a code difference as a product of the slope and a power difference defined at line 6 of Pseudocode 1. For example, the power difference is defined as the difference between a threshold output power and a current value of the output power of the PA. At line 21 of Pseudocode 1, the calibration circuitry 206 sets an upper threshold for the code difference based on whether the current value of the output power satisfies the threshold output as described above. For example, if the current value of the output power does not satisfy the threshold output power, the calibration circuitry 206 configures the format of a variable to store the code difference to 4.12 format. Also, if the current value of the output power satisfies the threshold output power, the calibration circuitry 206 configures the format of the variable to store the code difference to 3.13 format.

Flowcharts representative of at least one of example machine-readable instructions, which may be executed by programmable circuitry to at least one of implement or instantiate the radar control circuitry 102 of FIG. 2 or example operations which may be performed by programmable circuitry to at least one of implement or instantiate the radar control circuitry 102 of FIG. 2, are shown in FIGS. 6 and 7. The machine-readable instructions may be at least one of one or more executable programs or portion(s) of one or more executable programs for execution by programmable circuitry such as the programmable circuitry 812 shown in the example programmable circuitry platform 800 described below in connection with FIG. 8 or one or more function(s) or portion(s) of functions to be performed by the example programmable circuitry (e.g., an FPGA) described below in connection with at least one of FIG. 9 or 10. In some examples, the machine-readable instructions cause an operation, a task, etc., to be at least one of carried out or performed in an automated manner in the real world. As used herein, “automated” means without human involvement.

The program may be embodied in instructions (e.g., at least one of software or firmware) stored on at least one of one or more non-transitory computer-readable or machine-readable storage medium such as at least one of cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), or any other storage device or storage disk. The instructions of at least one of the non-transitory computer-readable or the machine-readable medium may at least one of program or be executed by programmable circuitry located in one or more hardware devices, but at least one of the entire program or parts thereof could alternatively be at least one of executed or instantiated by one or more hardware devices other than at least one of the programmable circuitry or embodied in dedicated hardware. The machine-readable instructions may be distributed across at least one of multiple hardware devices or executed by two or more hardware devices (e.g., a server and a client hardware device). For example, the client hardware device may be implemented by an endpoint client hardware device (e.g., a hardware device associated with at least one of a human user or machine user) or an intermediate client hardware device gateway (e.g., a radio access network (RAN)) that may facilitate communication between a server and an endpoint client hardware device. Similarly, the non-transitory computer-readable storage medium may include one or more mediums. Further, although the example program is described with reference to the flowcharts illustrated in FIGS. 6 and 7, many other methods of implementing the example radar control circuitry 102 may alternatively be used. For example, the order of execution of the blocks of the flowchart(s) may be at least one of changed, or some of the blocks described may be changed, eliminated, or combined. Also or alternatively, any or all of the blocks of the flow chart may be implemented by one or more hardware circuits (e.g., processor circuitry, discrete analog circuitry, discrete digital circuitry, integrated analog circuitry, integrated digital circuitry, an FPGA, an ASIC, a comparator, an operational-amplifier (op-amp), a logic circuit, etc.) structured to perform the corresponding operation without executing software or firmware. The programmable circuitry may be distributed in at least one of different network locations or local to one or more hardware devices (e.g., a single-core processor (e.g., a single core CPU), a multi-core processor (e.g., a multi-core CPU, an XPU, etc.)). For example, the programmable circuitry may be one or more of at least one of a CPU or an FPGA located in the same package (e.g., the same integrated circuit (IC) package or in two or more separate housings), one or more processors in a single machine, multiple processors distributed across multiple servers of a server rack, multiple processors distributed across one or more server racks, etc., or any combination(s) thereof.

The machine-readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to at least one of create, manufacture, or produce machine-executable instructions. For example, the machine-readable instructions may be fragmented and stored on at least one of one or more storage devices, one or more disks, or one or more computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to produce instructions that are at least one of directly readable, directly interpretable, or directly executable by at least one of a computing device or other machine. For example, the machine-readable instructions may be stored in multiple parts, which are at least one of individually compressed, individually encrypted, or individually stored on separate computing devices, and the parts, when at least one of decrypted, decompressed, or combined, form at least one of a set of computer-executable or a set of machine-executable instructions that implement at least one of one or more functions or one or more operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before at least one of the machine-readable instructions or the corresponding program(s) can be executed in whole or in part. Thus, at least one of machine-readable, computer-readable, or machine-readable media, as used herein, may include at least one of instructions or program(s) regardless of the particular format or state of at least one of the machine-readable instructions or program(s).

The machine-readable instructions described herein can be represented by any past, present, or future instruction language, scripting language, programming language, etc. For example, the machine-readable instructions may be represented using any of the following languages: C, C++, Java, C Sharp, Perl, Python, JavaScript, HyperText Markup Language (HTML), Structured Query Language (SQL), Swift, etc.

As mentioned above, the example operations of FIGS. 6 and 7 may be implemented using executable instructions (e.g., computer-readable, machine-readable instructions, etc.) stored on at least one of one or more non-transitory computer-readable or one or more machine-readable media. As used herein, at least one of the terms non-transitory computer-readable medium, non-transitory computer-readable storage medium, non-transitory machine-readable medium, or non-transitory machine-readable storage medium are expressly defined to include at least one of any type of computer-readable storage device or any type of storage disk and to exclude propagating signals and to exclude transmission media. Examples of at least one of such non-transitory computer-readable medium, non-transitory computer-readable storage medium, non-transitory machine-readable medium, or non-transitory machine-readable storage medium include at least one of optical storage devices, magnetic storage devices, an HDD, a flash memory, a read-only memory (ROM), a CD, a DVD, a cache, a RAM of any type, a register, or any other storage device or storage disk in which information is stored for any duration (e.g., for extended time periods, permanently, for brief instances, for temporarily buffering, for caching of the information, etc.). As used herein, the terms “non-transitory computer-readable storage device” and “non-transitory machine-readable storage device” are defined to include any physical (mechanical, at least one of magnetic or electrical) hardware to retain information for a time period, but to exclude propagating signals and to exclude transmission media. Examples of at least one of non-transitory computer-readable storage devices or non-transitory machine-readable storage devices include at least one of random-access memory of any type, read only memory of any type, solid state memory, flash memory, optical discs, magnetic disks, disk drives, or redundant array of independent disks (RAID) systems. As used herein, the term “device” refers to physical structure such as at least one of one or more of mechanical or electrical equipment, hardware, or circuitry that may or may not be at least one of configured by computer-readable instructions, machine-readable instructions, etc., or manufactured to execute computer-readable instructions, machine-readable instructions, etc.

FIG. 8 is a block diagram of an example programmable circuitry platform 800 structured to at least one of execute or instantiate at least one of the example machine-readable instructions or the example operations of FIGS. 6 and 7 to implement the radar control circuitry 102 of FIG. 2. The programmable circuitry platform 800 can be, for example, a radar SoC, or at least one of any other type of computing device or any other type or electronic device.

The programmable circuitry platform 800 of the illustrated example includes programmable circuitry 812. The programmable circuitry 812 of the illustrated example is hardware. For example, the programmable circuitry 812 can be implemented by at least one of one or more integrated circuits, one or more logic circuits, one or more FPGAs, one or more microprocessors, one or more CPUs, one or more GPUs, one or more DSPs, or one or more microcontrollers from any desired family or manufacturer. The programmable circuitry 812 may be implemented by one or more semiconductor based (e.g., silicon based) devices. In this example, the programmable circuitry 812 implements the example controller circuitry 204 and the example calibration circuitry 206.

The programmable circuitry 812 of the illustrated example includes a local memory 813 (e.g., a cache, registers, etc.). The programmable circuitry 812 of the illustrated example is in communication with main memory 814, 816, which includes a volatile memory 814 and a non-volatile memory 816, by a bus 818. The volatile memory 814 may be implemented by at least one of Synchronous Dynamic Random Access Memory (SDRAM), Dynamic Random Access Memory (DRAM), RAMBUS® Dynamic Random Access Memory (RDRAM®), or any other type of RAM device. The non-volatile memory 816 may be implemented by at least flash memory or any other desired type of memory device. Access to the main memory 814, 816 of the illustrated example is controlled by a memory controller 817. In some examples, the memory controller 817 may be implemented by one or more integrated circuits, logic circuits, microcontrollers from any desired family or manufacturer, or any other type of circuitry to manage the flow of data going to and from the main memory 814, 816.

The programmable circuitry platform 800 of the illustrated example also includes interface circuitry 820. The interface circuitry 820 may be implemented by hardware per any type of interface standard, such as at least one of an Ethernet interface, a universal serial bus (USB) interface, a Bluetooth® interface, a near field communication (NFC) interface, a Peripheral Component Interconnect (PCI) interface, or a Peripheral Component Interconnect Express (PCIe) interface.

In the illustrated example, one or more input devices 822 are connected to the interface circuitry 820. The input device(s) 822 permit(s) a user (e.g., a human user, a machine user, etc.) to enter at least one of data or commands into the programmable circuitry 812. The input device(s) 822 can be implemented by, for example, at least one of an audio sensor, a microphone, or a camera (still or video).

One or more output devices 824 are also connected to the interface circuitry 820 of the illustrated example. The output device(s) 824 can be implemented, for example, by a speaker. The interface circuitry 820 of the illustrated example, thus, may include at least one of a graphics driver card, a graphics driver chip, or graphics processor circuitry such as a GPU.

The interface circuitry 820 of the illustrated example also includes a communication device such as at least one of a transmitter, a receiver, a transceiver, a modem, a residential gateway, a wireless access point, or a network interface to facilitate exchange of data with external machines (e.g., computing devices of any kind) by a network 826. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc. In this example, the interface circuitry 820 implements the example interface circuitry 202.

The programmable circuitry platform 800 of the illustrated example also includes one or more mass storage discs or devices 828 to store at least one of firmware, software, or data. Examples of such mass storage discs or devices 828 include at least one of magnetic storage devices (e.g., floppy disk, drives, HDDs, etc.), optical storage devices (e.g., Blu-ray disks, CDs, DVDs, etc.), RAID systems, or solid-state storage discs or devices such as at least one of flash memory devices or SSDs. In this examples, the one or more mass storage discs or devices 828 implement the datastore 208.

The machine-readable instructions 832, which may be implemented by the machine-readable instructions of FIGS. 6 and 7, may be stored in at least one of the mass storage device 828, in the volatile memory 814, in the non-volatile memory 816, or on at least one non-transitory computer-readable storage medium such as a CD or DVD which may be removable.

FIG. 9 is a block diagram of an example implementation of the programmable circuitry 812 of FIG. 8. In this example, the programmable circuitry 812 of FIG. 8 is implemented by a microprocessor 900. For example, the microprocessor 900 may be a general-purpose microprocessor (e.g., general-purpose microprocessor circuitry). The microprocessor 900 executes some or all of the machine-readable instructions of the flowcharts of FIGS. 6 and 7 to effectively instantiate the circuitry of FIG. 2 as logic circuits to perform operations corresponding to those machine-readable instructions. In some such examples, the circuitry of FIG. 2 is instantiated by the hardware circuits of the microprocessor 900 in combination with the machine-readable instructions. For example, the microprocessor 900 may be implemented by multi-core hardware circuitry such as a CPU, a DSP, a GPU, an XPU, etc. Although it may include any number of example cores 902 (e.g., 1 core), the microprocessor 900 of this example is a multi-core semiconductor device including N cores. The cores 902 of the microprocessor 900 may operate independently or may cooperate to execute machine-readable instructions.

For example, machine code corresponding to a firmware program, an embedded software program, or a software program may be executed by one of the cores 902 or may be executed by multiple ones of the cores 902 at the same or different times. In some examples, the machine code corresponding to the firmware program, the embedded software program, or the software program is split into threads and executed in parallel by two or more of the cores 902. The software program may correspond to a portion or all of at least one of the machine-readable instructions or operations represented by the flowcharts of FIGS. 6 and 7.

The cores 902 may communicate by a first example bus 904. In some examples, the first bus 904 may be implemented by a communication bus to effectuate communication associated with one(s) of the cores 902. For example, the first bus 904 may be implemented by at least one of an Inter-Integrated Circuit (I2C) bus, a Serial Peripheral Interface (SPI) bus, a PCI bus, or a PCIe bus. Also or alternatively, the first bus 904 may be implemented by any other type of computing or electrical bus. The cores 902 may obtain at least one of data, instructions, or signals from one or more external devices by example interface circuitry 906. The cores 902 may output at least one of data, instructions, or signals to the one or more external devices by the interface circuitry 906. Although the cores 902 of this example include example local memory 920 (e.g., Level 1 (L1) cache that may be split into an L1 data cache and an L1 instruction cache), the microprocessor 900 also includes example shared memory 910 that may be shared by the cores (e.g., Level 2 (L2 Cache)) for high-speed access to at least one of data or instructions. At least one of data or instructions may be transferred (e.g., shared) by at least one of writing to or reading from the shared memory 910. The local memory 920 of each of the cores 902 and the shared memory 910 may be part of a hierarchy of storage devices including multiple levels of cache memory and the main memory (e.g., the main memory 814, 816 of FIG. 8). Higher levels of memory in the hierarchy exhibit lower access time and have smaller storage capacity than lower levels of memory. Changes in the various levels of the cache hierarchy are managed (e.g., coordinated) by a cache coherency policy.

Each core 902 may be referred to as a CPU, DSP, GPU, etc., or any other type of hardware circuitry. Each core 902 includes control unit circuitry 914, arithmetic and logic (AL) circuitry 916 (sometimes referred to as an ALU), a plurality of registers 918, the local memory 920, and a second example bus 922. Other structures may be present. For example, each core 902 may include vector unit circuitry, single instruction multiple data (SIMD) unit circuitry, load/store unit (LSU) circuitry, branch/jump unit circuitry, floating-point unit (FPU) circuitry, etc. The control unit circuitry 914 includes semiconductor-based circuits structured to control (e.g., coordinate) data movement within the corresponding core 902. The AL circuitry 916 includes semiconductor-based circuits structured to perform at least one of one or more mathematic operations or one or more logic operations on the data within the corresponding core 902. The AL circuitry 916 of some examples performs integer-based operations. In other examples, the AL circuitry 916 also performs floating-point operations. In yet other examples, the AL circuitry 916 may include first AL circuitry that performs integer-based operations and second AL circuitry that performs floating-point operations. In some examples, the AL circuitry 916 may be referred to as an Arithmetic Logic Unit (ALU).

The registers 918 are semiconductor-based structures to store at least one of data or instructions such as results of one or more of the operations performed by the AL circuitry 916 of the corresponding core 902. For example, the registers 918 may include vector register(s), SIMD register(s), general-purpose register(s), flag register(s), segment register(s), machine-specific register(s), instruction pointer register(s), control register(s), debug register(s), memory management register(s), machine check register(s), etc. The registers 918 may be arranged in a bank as shown in FIG. 9. Alternatively, the registers 918 may be organized in any other arrangement, format, or structure, such as by being distributed throughout the core 902 to shorten access time. The second bus 922 may be implemented by at least one of an I2C bus, a SPI bus, a PCI bus, or a PCIe bus.

Each core 902 or, more generally, the microprocessor 900 may include additional or alternate structures to those shown and described above. For example, at least one of one or more clock circuits, one or more power supplies, one or more power gates, one or more cache home agents (CHAs), one or more converged/common mesh stops (CMSs), one or more shifters (e.g., barrel shifter(s)) or other circuitry may be present. The microprocessor 900 is a semiconductor device fabricated to include many transistors interconnected to implement the structures described above in one or more integrated circuits (ICs) contained in one or more packages.

The microprocessor 900 may at least one of include or cooperate with one or more accelerators (e.g., acceleration circuitry, hardware accelerators, etc.). In some examples, accelerators are implemented by logic circuitry to perform certain tasks at least one of (a) more quickly or (b) more efficiently than can be done by a general-purpose processor. Examples of accelerators include ASICs and FPGAs such as those described herein. At least one of a GPU, a DSP or other programmable device can also be an accelerator. Accelerators may be at least one of on-board the microprocessor 900, in the same chip package as the microprocessor 900 or in one or more separate packages from the microprocessor 900.

FIG. 10 is a block diagram of another example implementation of the programmable circuitry 812 of FIG. 8. In this example, the programmable circuitry 812 is implemented by FPGA circuitry 1000. For example, the FPGA circuitry 1000 may be implemented by an FPGA. The FPGA circuitry 1000 can be used, for example, to perform operations that could otherwise be performed by the example microprocessor 900 of FIG. 9 executing corresponding machine-readable instructions. However, once configured, the FPGA circuitry 1000 instantiates at least one of the operations or the functions corresponding to the machine-readable instructions in hardware and, thus, can often execute the operations/functions faster than they could be performed by a general-purpose microprocessor executing the corresponding software.

More specifically, in contrast to the microprocessor 900 of FIG. 9 described above (which is a general purpose device that may be programmed to execute some or all of the machine-readable instructions represented by the flowchart(s) of FIGS. 6 and 7 but whose interconnections and logic circuitry are fixed once fabricated), the FPGA circuitry 1000 of the example of FIG. 10 includes interconnections and logic circuitry that may be at least one of configured, structured, programmed, or interconnected in different ways after fabrication to instantiate, for example, some or all of the operations/functions corresponding to the machine-readable instructions represented by the flowchart(s) of FIGS. 6 and 7. In particular, the FPGA circuitry 1000 may be thought of as an array of logic gates, interconnections, and switches. The switches can be programmed to change how the logic gates are interconnected by the interconnections, effectively forming one or more dedicated logic circuits (unless and until the FPGA circuitry 1000 is reprogrammed). The configured logic circuits enable the logic gates to cooperate in different ways to perform different operations on data received by input circuitry. Those operations may correspond to some or all of the instructions (e.g., at least one of the software or the firmware) represented by the flowchart(s) of FIGS. 6 and 7. As such, the FPGA circuitry 1000 may be structured to effectively instantiate some or all of the operations/functions corresponding to the machine-readable instructions of the flowchart(s) of FIGS. 6 and 7 as dedicated logic circuits to perform the operations/functions corresponding to those software instructions in a dedicated manner analogous to an ASIC. Therefore, the FPGA circuitry 1000 may perform the operations/functions corresponding to the some or all of the machine-readable instructions of FIGS. 6 and 7 faster than the general-purpose microprocessor can execute the same.

In the example of FIG. 10, the FPGA circuitry 1000 is at least one of configured or structured in response to being programmed (or reprogrammed one or more times) based on a binary file. In some examples, the binary file may be at least one of compiled or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1000 of FIG. 10 may at least one of access or load the binary file to perform the one or more operations/functions. For example, the binary file may be implemented by at least one of a bit stream (e.g., one or more computer-readable bits, one or more machine-readable bits, etc.), data (e.g., computer-readable data, machine-readable data, etc.), or machine-readable instructions accessible to the FPGA circuitry 1000 of FIG. 10 to configure or structure the FPGA circuitry 1000 of FIG. 10, or portion(s) thereof.

In some examples, the binary file is at least one of compiled, generated, transformed, or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is at least one of compiled, generated, or otherwise output from the uniform software platform based on the second instructions. In some examples, the FPGA circuitry 1000 of FIG. 10 may at least one of access or load the binary file to perform the one or more operations/functions. For example, the binary file may be implemented by at least one of a bit stream (e.g., one or more computer-readable bits, one or more machine-readable bits, etc.), data (e.g., computer-readable data, machine-readable data, etc.), or machine-readable instructions accessible to the FPGA circuitry 1000 of FIG. 10 to configure or structure the FPGA circuitry 1000 of FIG. 10, or portion(s) thereof.

The FPGA circuitry 1000 of FIG. 10, includes example input/output (I/O) circuitry 1002 to at least one of obtain or output data to/from at least one of example configuration circuitry 1004 or external hardware 1006. For example, the configuration circuitry 1004 may be implemented by interface circuitry that may obtain a binary file, which may be implemented by at least one of a bit stream, data, or machine-readable instructions, to configure the FPGA circuitry 1000, or portion(s) thereof. In some such examples, the configuration circuitry 1004 may obtain the binary file from at least one of a user, a machine (e.g., hardware circuitry (e.g., programmable or dedicated circuitry) that may implement an Artificial Intelligence/Machine Learning (AI/ML) model to generate the binary file), etc., or any combination(s) thereof. In some examples, the external hardware 1006 may be implemented by external hardware circuitry. For example, the external hardware 1006 may be implemented by the microprocessor 900 of FIG. 9.

The FPGA circuitry 1000 also includes an array of example logic gate circuitry 1008, a plurality of example configurable interconnections 1010, and example storage circuitry 1012. The logic gate circuitry 1008 and the configurable interconnections 1010 are configurable to instantiate one or more operations/functions that may correspond to at least some of the machine-readable instructions of FIGS. 6 and 7 or other desired operations. The logic gate circuitry 1008 shown in FIG. 10 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1008 to enable configuration of at least one of the electrical structures or the logic gates to form circuits to perform desired operations/functions. The logic gate circuitry 1008 may include other electrical structures such as look-up tables (LUTs), registers (e.g., flip-flops or latches), multiplexers, etc.

The configurable interconnections 1010 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1008 to program desired logic circuits.

The storage circuitry 1012 of the illustrated example is structured to store result(s) of the one or more of the operations performed by corresponding logic gates. The storage circuitry 1012 may be implemented by registers or the like. In the illustrated example, the storage circuitry 1012 is distributed amongst the logic gate circuitry 1008 to facilitate access and increase execution speed.

The example FPGA circuitry 1000 of FIG. 10 also includes example dedicated operations circuitry 1014. In this example, the dedicated operations circuitry 1014 includes special purpose circuitry 1016 that may be invoked to implement commonly used functions to avoid the need to program those functions in the field. Examples of such special purpose circuitry 1016 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1000 may also include example general purpose programmable circuitry 1018 such as at least one of an example CPU 1020 or an example DSP 1022. Other general purpose programmable circuitry 1018 may also or alternatively be present such as a GPU, an XPU, etc., that can be programmed to perform other operations.

Although FIGS. 9 and 10 illustrate two example implementations of the programmable circuitry 812 of FIG. 8, many other approaches are contemplated. For example, FPGA circuitry may include an on-board CPU, such as one or more of the example CPU 1020 of FIG. 9. Therefore, the programmable circuitry 812 of FIG. 8 may also be implemented by combining at least the example microprocessor 900 of FIG. 9 and the example FPGA circuitry 1000 of FIG. 10. In some such hybrid examples, at least one of one or more cores 902 of FIG. 9 may execute a first portion of the machine-readable instructions represented by the flowchart(s) of FIGS. 6 and 7 to perform first operation(s)/function(s), the FPGA circuitry 1000 of FIG. 10 may be structured to perform second operation(s)/function(s) corresponding to a second portion of the machine-readable instructions represented by the flowcharts of FIGS. 6 and 7, or an ASIC may be structured to perform third operation(s)/function(s) corresponding to a third portion of the machine-readable instructions represented by the flowcharts of FIGS. 6 and 7.

Some or all of the circuitry of FIG. 2 may, thus, be instantiated at the same or different times. For example, at least one of same or different portion(s) of the microprocessor 900 of FIG. 9 may be programmed to execute portion(s) of machine-readable instructions at one or more of the same or different times. In some examples, at least one of same or different portion(s) of the FPGA circuitry 1000 of FIG. 10 may be structured to perform operations/functions corresponding to portion(s) of machine-readable instructions at one or more the same or different times.

In some examples, some or all of the circuitry of FIG. 2 may be instantiated, for example, in one or more threads executing at least one of concurrently or in series. For example, the microprocessor 900 of FIG. 9 may execute machine-readable instructions in one or more threads executing at least one of concurrently or in series. In some examples, the FPGA circuitry 1000 of FIG. 10 may be structured to carry out operations/functions at least one of concurrently or in series. Moreover, in some examples, some or all of the circuitry of FIG. 2 may be implemented within at least one of one or more virtual machines or one or more containers executing on the microprocessor 900 of FIG. 9.

In some examples, the programmable circuitry 812 of FIG. 8 may be in one or more packages. For example, at least one of the microprocessor 900 of FIG. 9 or the FPGA circuitry 1000 of FIG. 10 may be in one or more packages. In some examples, an XPU may be implemented by the programmable circuitry 812 of FIG. 8, which may be in one or more packages. For example, the XPU may include a CPU (e.g., the microprocessor 900 of FIG. 9, the CPU 1020 of FIG. 10, etc.) in one package, a DSP (e.g., the DSP 1022 of FIG. 10) in another package, a GPU in yet another package, and an FPGA (e.g., the FPGA circuitry 1000 of FIG. 10) in still yet another package.

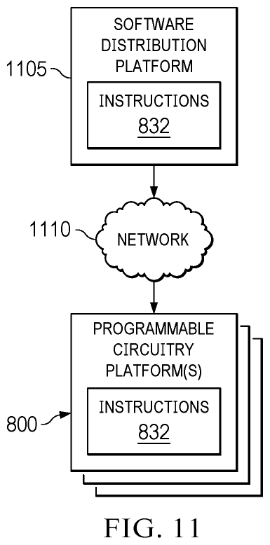

A block diagram illustrating an example software distribution platform 1105 to distribute software such as the example machine-readable instructions 832 of FIG. 8 to other hardware devices (e.g., hardware devices at least one of owned or operated by third parties from at least one of the owner or operator of the software distribution platform) is illustrated in FIG. 11. The example software distribution platform 1105 may be implemented by any computer server, data facility, cloud service, etc., capable of storing and transmitting software to other computing devices. The third parties may be customers of the entity at least one of owning or operating the software distribution platform 1105. For example, the entity that at least one of owns or operates the software distribution platform 1105 may be at least one of a developer, a seller, or a licensor of software such as the example machine-readable instructions 832 of FIG. 8. The third parties may be consumers, users, retailers, OEMs, etc., who at least one of purchase or license the software for at least one of use, re-sale, or sub-licensing. In the illustrated example, the software distribution platform 1105 includes one or more servers and one or more storage devices. The storage devices store the machine-readable instructions 832, which may correspond to the example machine-readable instructions of FIGS. 6 and 7, as described above. The one or more servers of the example software distribution platform 1105 are in communication with an example network 1110, which may correspond to any one or more of the Internet or any of the example networks described above. In some examples, the one or more servers are responsive to requests to transmit the software to a requesting party as part of a commercial transaction. Payment for at least one of the delivery, the sale, or the license of the software may be handled by at least one of the one or more servers of the software distribution platform or by a third-party payment entity. The servers enable at least one of purchasers or licensors to download the machine-readable instructions 832 from the software distribution platform 1105. For example, the software, which may correspond to the example machine-readable instructions of FIGS. 6 and 7, may be downloaded to the example programmable circuitry platform 800, which is to execute the machine-readable instructions 832 to implement the radar control circuitry 102. In some examples, one or more servers of the software distribution platform 1105 at least one of periodically offer, periodically transmit, or periodically force updates to the software (e.g., the example machine-readable instructions 832 of FIG. 8) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or actions may be implemented by, e.g., the same entity or object. Also, although individual features may be included in different examples or claims, these may possibly be combined, and the inclusion in different examples or claims does not imply that a combination of features is not feasible or not advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used herein, connection references (e.g., attached, coupled, connected, and joined) may include at least one of intermediate members between the elements referenced by the connection reference or relative movement between those elements unless otherwise indicated. As such, connection references do not necessarily infer that two elements are at least one of directly connected or in fixed relation to each other.

Unless specifically stated otherwise, descriptors such as “first,” “second,” “third,” etc., are used herein without imputing or otherwise indicating any meaning of at least one of priority, physical order, arrangement in a list, or ordering in any way, but are merely used as at least one of labels or arbitrary names to distinguish elements for ease of understanding the described examples. In some examples, the descriptor “first” may be used to refer to an element in the detailed description, while the same element may be referred to in a claim with a different descriptor such as “second” or “third.” In such instances, such descriptors are used merely for identifying those elements distinctly within the context of the discussion (e.g., within a claim) in which the elements might, for example, otherwise share a same name.

As used herein, the phrase “in communication,” including variations thereof, encompasses at least one of direct communication or indirect communication through one or more intermediary components, and does not require at least one of direct physical (e.g., wired) communication or constant communication, but rather also includes selective communication at one or more of periodic intervals, scheduled intervals, aperiodic intervals, or one-time events.

As used herein, “programmable circuitry” is defined to include at least one of (i) one or more special purpose electrical circuits (e.g., an application specific circuit (ASIC)) structured to perform specific operation(s) and including one or more semiconductor-based logic devices (e.g., electrical hardware implemented by one or more transistors), or (ii) one or more general purpose semiconductor-based electrical circuits programmable with instructions to perform at least one of specific functions(s) or specific operation(s) and including one or more semiconductor-based logic devices (e.g., electrical hardware implemented by one or more transistors). Examples of programmable circuitry include programmable microprocessors such as at least one of Central Processor Units (CPUs) that may execute first instructions to perform at least one of one or more operations or one or more functions, Field Programmable Gate Arrays (FPGAs) that may be programmed with second instructions to configure or structure the FPGAs to instantiate at least one of one or more operations or one or more functions corresponding to the first instructions, Graphics Processor Units (GPUs) that may execute first instructions to perform at least one of one or more operations or one or more functions, Digital Signal Processors (DSPs) that may execute first instructions to perform at least one of one or more operations or one or more functions, XPUs, Network Processing Units (NPUs), one or more microcontrollers that may execute first instructions to perform at least one of one or more operations or one or more functions, or integrated circuits such as Application Specific Integrated Circuits (ASICs). For example, an XPU may be implemented by a heterogeneous computing system including multiple types of programmable circuitry (e.g., at least two of one or more FPGAs, one or more CPUs, one or more GPUs, one or more NPUs, one or more DSPs, etc., or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

In this description, the phrase “at least one of A or B” (or “at least one of A and B”) refers to implementations including any of: (a) at least one A; (b) at least one B; and (c) at least one A and at least one B.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

Numerical identifiers such as “first,” “second,” “third,” etc. are used merely to distinguish between elements of substantially the same type in terms of at least one of structure or function. These identifiers, as used in the detailed description, do not necessarily align with those used in the claims.

A device that is “configured to” perform a task or function may be at least one of configured (e.g., at least one of programmed or hardwired) at a time of manufacturing by a manufacturer to perform the function or configurable (or re-configurable) by a user after manufacturing to perform at least one of the function or other additional or alternative functions. The configuring may be through at least one of firmware or software programming of the device, through at least one of a construction or layout of hardware components and interconnections of the device, or a combination thereof.

As used herein, the terms “terminal” and “interconnection(s)” may include at least one of pin(s) or lead(s). Unless specifically stated to the contrary, these terms are generally used to mean an interconnection between or a terminus of a device element, a circuit element, an integrated circuit, a device or other electronics or semiconductor component.

A circuit or device that is described herein as including certain components may instead be adapted to be coupled to those components to form the described circuitry or device. For example, a structure described as including at least one of one or more semiconductor elements (such as transistors), one or more passive elements (such as resistors, capacitors, inductors, etc.), or one or more sources (such as voltage sources, current sources, etc.) may instead include only the semiconductor elements within a single physical device (e.g., a semiconductor die, integrated circuit (IC) package, etc.) and may be adapted to be coupled to one or more of at least some of the passive elements or the sources to form the described structure either at a time of manufacture or after a time of manufacture, for example, by at least one of an end-user or a third-party.

Circuits described herein are reconfigurable to include the replaced components to provide functionality at least partially similar to functionality available prior to the component replacement. Components shown as resistors, unless otherwise stated, are generally representative of any one or more elements coupled at least one of in series or parallel to provide an amount of impedance represented by the shown resistor. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor. While certain elements of the described examples are included in an integrated circuit and other elements are external to the integrated circuit, in other example embodiments, additional or fewer features may be incorporated into the integrated circuit. In addition, at least one of some or all of the features illustrated as being external to the integrated circuit may be included in the integrated circuit or some features illustrated as being internal to the integrated circuit may be incorporated outside of the integrated. As used herein, the term “integrated circuit” means one or more circuits that are at least one of: (i) incorporated in/over a semiconductor substrate; (ii) incorporated in a single semiconductor package; (iii) incorporated into the same module; or (iv) incorporated in/on the same printed circuit board.

Stated numerical values may vary a reasonable amount, e.g., +/−10 percent of the stated value, or, if the value is zero, a reasonable range of values around zero.

Modifications are possible in the described embodiments, and other embodiments are possible, within the scope of the claims.

From the foregoing, it will be appreciated that example systems, apparatus, articles of manufacture, and methods have been described that improve calibration of transmitter circuitry to facilitate reliable performance of the transmitter circuitry across split lots. For example, split lots refer to circuitry having different operating characteristics based on different manufacturing conditions. Circuitry from split lots can be at least one of different circuitry on the same wafer or circuitry from different wafers. Also, examples described herein prevent failure of transmitter circuitry calibration. Examples described herein improve overall accuracy of calibration (e.g., CLPC) with a reduced number of iterations and regardless of erroneous analog measurements.

Example systems, apparatus, articles of manufacture, and methods described herein include slope direction control and slope dampening control within an example CLPC algorithm (e.g., the NR algorithm). Examples described herein also avoid complications arising from utilizing an example CLPC algorithm when at least one of iterating over the NR algorithm for a finite number of iterations or utilizing erroneous inputs. Also, described examples calibrate transmitter circuitry in less time than other techniques while preventing calibration failure and reducing calibration error.

For example, described systems, apparatus, articles of manufacture, and methods include intermittent calibration of transmitter circuitry without failure and improve CLPC-based power accuracy (e.g., by 2 dB). Described systems, apparatus, articles of manufacture, and methods improve the efficiency of using a computing device by providing calibrated transmitter circuitry in a radar circuit without failure and in less time than other techniques. Described systems, apparatus, articles of manufacture, and methods are accordingly directed to one or more improvement(s) in the operation of a machine such as a computer or at least one of other electronic device or other mechanical device.

What is claimed is:

1. At least one non-transitory machine-readable storage medium comprising machine-readable instructions to cause at least one processor circuit to at least:
set a control voltage of a power amplifier (PA) of a radar circuit based on a bias code;
cause a power detector of the radar circuit to measure an output power of the PA; and
based on a rate of change of the bias code with respect to the output power not corresponding to a change in value of the bias code, set the rate of change based on first values of the bias code and second values of the output power.

2. The at least one non-transitory machine-readable storage medium of claim 1, wherein the machine-readable instructions are to cause one or more of the at least one processor circuit to set the rate of change based on (1) a first difference between a current value of the bias code and a previous value of the bias code and (2) a second difference between a current value of the output power and a previous value of the output power.

3. The at least one non-transitory machine-readable storage medium of claim 1, wherein the machine-readable instructions are to cause one or more of the at least one processor circuit to:
determine a code delta for the bias code based on the rate of change, a current value of the output power, and a threshold output power; and
set the bias code based on a current value of the bias code and the code delta.

4. The at least one non-transitory machine-readable storage medium of claim 1, wherein the machine-readable instructions are to cause one or more of the at least one processor circuit to:
compare the output power to a threshold output power;
based on the output power not satisfying the threshold output power, set an upper threshold for a code delta for the bias code to a first threshold value; and
based on the output power satisfying the threshold output power, set the upper threshold for the code delta to a second threshold value different than the first threshold value.

5. The at least one non-transitory machine-readable storage medium of claim 4, wherein the machine-readable instructions are to cause one or more of the at least one processor circuit to, based on the output power not satisfying the threshold output power, cause storage of the upper threshold for the code delta in 4.12 format.

6. The at least one non-transitory machine-readable storage medium of claim 4, wherein the machine-readable instructions are to cause one or more of the at least one processor circuit to, based on the output power satisfying the threshold output power, cause storage of the upper threshold for the code delta in 3.13 format.

7. The at least one non-transitory machine-readable storage medium of claim 1, wherein the second values of the output power correspond to performance of the PA for the first values of the bias code when measured by the power detector without saturation.

8. A radar circuit comprising:
transmitter circuitry including a power amplifier (PA) and a power detector (PD), the PA coupled to the PD; and
control circuitry coupled to the transmitter circuitry, the control circuitry configured to:
set a control voltage of the PA based on a bias code;
cause the PD to measure an output power of the PA; and
based on a rate of change of the bias code with respect to the output power not corresponding to a change in value of the bias code, set the rate of change based on first values of the bias code and second values of the output power.

9. The radar circuit of claim 8, wherein the control circuitry is configured to set the rate of change based on (1) a first difference between a current value of the bias code and a previous value of the bias code and (2) a second difference between a current value of the output power and a previous value of the output power.

10. The radar circuit of claim 8, wherein the control circuitry is configured to:
determine a code delta for the bias code based on the rate of change, a current value of the output power, and a threshold output power; and
set the bias code based on a current value of the bias code and the code delta.

11. The radar circuit of claim 8, wherein the control circuitry is configured to:
compare the output power to a threshold output power;
based on the output power not satisfying the threshold output power, set an upper threshold for a code delta for the bias code to a first threshold value; and
based on the output power satisfying the threshold output power, set the upper threshold for the code delta to a second threshold value different than the first threshold value.

12. The radar circuit of claim 11, wherein based on the output power not satisfying the threshold output power, the control circuitry is configured to cause storage of the upper threshold for the code delta in 4.12 format.

13. The radar circuit of claim 11, wherein based on the output power satisfying the threshold output power, the control circuitry is configured to cause storage of the upper threshold for the code delta in 3.13 format.

14. The radar circuit of claim 8, wherein the second values of the output power correspond to performance of the PA for the first values of the bias code when measured by the PD without saturation.

15. A method comprising:
generating, with a power amplifier (PA) of a radar circuit, a signal based on a bias code;
measuring, with a power detector of the radar circuit, a power of the signal generated by the PA; and
based on a rate of change of the bias code with respect to the power not corresponding to a change in value of the bias code, setting, by using control circuitry, the rate of change based on first values of the bias code and second values of the power.

16. The method of claim 15, further including setting the rate of change based on (1) a first difference between a current value of the bias code and a previous value of the bias code and (2) a second difference between a current value of the power and a previous value of the power.

17. The method of claim 15, further including:
determining a code delta for the bias code based on the rate of change, a current value of the power, and a threshold power; and
setting the bias code based on a current value of the bias code and the code delta.

18. The method of claim 15, further including:
comparing the power to a threshold power;
based on the power not satisfying the threshold power, setting an upper threshold for a code delta for the bias code to a first threshold value; and
based on the power satisfying the threshold power, setting the upper threshold for the code delta to a second threshold value different than the first threshold value.

19. The method of claim 18, further including, based on the power not satisfying the threshold power, causing storage of the upper threshold for the code delta in 4.12 format.

20. The method of claim 18, further including, based on the power satisfying the threshold power, causing storage of the upper threshold for the code delta in 3.13 format.
